(19) United States
(12) Patent Application Publication
(10) Pub. No.: US 2014/0175909 A1
(43) Pub. Date: Jun. 26, 2014

(54) Systems and Methods for Supporting a Movable Element of an Electromechanical Device

(71) Applicant: Pixtronix, Inc., (US)

(72) Inventors: Joyce H. Wu, Somerville, MA (US); Jasper Lodewyk Steyn, Winchester, MA (US)

(73) Assignee: Pixtronix, Inc., San Diego, CA (US)

(21) Appl. No.: 13/724,671

(22) Filed: Dec. 21, 2012

(51) Int. Cl. H02K 41/02

(52) U.S. Cl. CPC H02K 41/02
USPC 310/12.04; 310/12.27

(57) ABSTRACT

An electromechanical device includes a movable body that is movable along an axis of a direction of motion. The device also includes an actuator beam and a compliant support beam arranged to support the movable body. The compliant support beam includes a first end connected to an anchor and an actuating portion extending from the anchor and in a direction that is transverse to the axis of the direction of motion and away from the anchor. The actuating portion is also arranged adjacently and spaced apart from the actuator beam. The compliant support beam also includes a connector portion that is contiguous with the actuating portion and coupled to the movable body. The connector portion extends at least partially back toward the anchor while being arranged adjacently and spaced apart from the actuating portion.

### TECHNICAL FIELD

This disclosure relates to the field of electromechanical devices, and more particularly, to movable elements of electromechanical devices.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, or other micromachining processes that etch away parts of substrates and/or deposited material layers, or that add layers to form electrical and electromechanical devices.

MEMS devices can function as switches, sensors, and display elements for devices such as cellular telephones, consumer electronic devices, and television monitors or displays. Certain displays incorporate mechanical light modulators that use movable electromechanical elements to perform light modulation. These displays can include hundreds, thousands, or in some cases, millions of moving elements. In some devices, every movement of an element is susceptible to misalignment which could disable or drastically reduce the performance and reliability of an electromechanical device.

Electromechanical devices often utilize actuators to effect the movement of elements during the device's operation. The arrangement of movable elements affects the performance of the actuator. A shutter within a mechanical light modulator is one type of movable element or body. Some existing shutter-based electromechanical light modulators rely on a support beam to support and position a shutter. Compliant support beams can include an actuating segment (e.g., electrode portion) that enables movement of the shutter. Movement of the shutter is effected by applying a voltage to the compliant support beam and a voltage to a corresponding actuator or drive beam spaced away from the compliant support beam. An electrostatic field between the actuating portion of the compliant support beam and the drive beam generates an attractive force between the actuating portion of the compliant support beam and the drive beam, thereby effecting movement of the shutter.

One problem with existing movable elements is that the movable element can be titled in a way that can adversely effect the operation of the movable element. For example, a movable element (e.g., a shutter) can have a portion that is tilted up or down in relation to a plane that includes a direction of motion of the movable element. The tilt can adversely effect the position or movement of the movable element by allowing the movable element to contact an opposing element such as a substrate, whether in a stationary position or while moving, resulting in stiction or degraded movement of the movable element. Excessive stiction can further result in excessive yield loss during manufacture of MEMS devices including movable elements. The tilt may also adversely affect the ability of the movable element to perform other functions such as, for example, block a portion of light from a light source. Hence, there is a need to support movable elements within an electromechanical device while mitigating the adverse effects of certain deformities or tilt of the movable elements.

A related problem with existing support beams for a movable element is that a support beam may have certain stresses which, when the beam is coupled to a movable element, a deformation is imparted to the movable element. It follows that this stress can affect the orientation of a coupled movable element. For example, the imparted stress can cause a portion of the movable element to deform upwards or downwards, resulting in stiction or degraded movement of the movable element. Hence, there is also a need to support movable elements within an electromechanical device in a way that mitigates the adverse effects of stress within a support beam when coupled to a movable element.

### SUMMARY

The systems, methods and devices of this disclosure each have several innovative aspects, no single one of which is solely responsible for the desirable attributes disclosed herein.

In one aspect, an electromechanical device includes a movable body that is movable along an axis of a direction of motion. The axis may be an imaginary line extending parallel to or along the direction of motion. The device also includes a first actuator beam and a first compliant support beam arranged to support the movable body. The first compliant support beam includes a first end connected to an anchor and an actuating portion extending from the anchor and in a direction that is transverse to the direction of motion and away from the anchor. The actuating portion is also arranged adjacently and spaced away from the first actuator beam. The first compliant support beam also includes a connector portion that is contiguous with the actuating portion and coupled to the movable body. The connector portion extends back toward the anchor while being arranged adjacently and spaced away from the actuating portion.

In one configuration, the connector portion connects to the movable body along a side facing the actuating portion of the complaint support beam. The connector portion may connect on or about a center location of the side. In another configuration, the connector portion connects to the movable body along a side substantially parallel to the axis of the direction of motion. The connector portion may include a loop back segment arranged to enable the connector portion to extend back adjacently with respect to the actuating portion. In certain configurations, the connector portion traverses or intersects the axis of the direction of motion. The electromechanical device may include a second actuator beam and a second compliant support beam.

In certain implementations, the movable body includes a shutter. The shutter may include one or more bumpers arranged to determine a distance of travel of the shutter in a direction along the axis of the direction of motion. One or more bumpers may include an electrode. One or more bumpers may be integrally formed on the shutter.

In some implementations, the electromechanical device is arranged as part of a display apparatus. The display apparatus may be arranged to communicate with a processor where the processor is configured to process image data and communicate with a memory device. The display apparatus may receive at least one signal from a driver circuit configured to receive at least a portion of the image data from a controller. The processor may be configured to receive the image data from an image source module where the image source module includes at least one of a receiver, transceiver, and transmitter. The processor may also be configured to receive input data from an input device that interfaces with a user.

In another aspect, a method for manufacturing an electromechanical device includes providing a movable body that is movable along an axis of a direction of motion and arranging a compliant support beam to support the movable body. The compliant support beam is arranged or configured by connecting a first end of the compliant support beam to an anchor and providing an actuator beam. An actuating portion of the compliant support beam is formed that extends from the anchor and transverse to the axis of the direction of motion. The actuating portion is arranged adjacent to the actuator beam and has a length for generating an electrostatic force sufficient to move the movable body along the axis of the direction of motion. The compliant support beam is also coupled via a connector portion contiguous with the actuating portion to the movable body where the connector portion extends back adjacently with respect to the actuating portion.

In one instance, the connector portion is coupled to the movable body along a side facing the actuating portion of the complaint support beam. The connector portion may be coupled on or about a center location of the side. In another instance, the connector portion is coupled to the movable body along an end wall substantially parallel to the axis of the direction of motion. A loop back segment may be formed within the compliant support beam to enable the connector portion to extend back adjacently with respect to the actuating portion.

In yet another aspect, a method of manufacturing an electromechanical device includes providing a substrate. Then, depositing a first layer of material over the substrate and patterning the first layer of material to form a movable body, a compliant support beam coupled to the movable body, an anchor, and an actuator beam spaced apart from the compliant support beam. The movable body may be configured to be movable along an axis of a direction of motion. The compliant support beam may be coupled to the anchor via a first end and coupled to the movable body via a connector portion. In one configuration, the compliant support beam includes an actuating portion extending from the anchor and in a direction that is transverse to the axis of the direction of motion and away from the anchor. The actuating portion may also be arranged adjacently and spaced apart from the actuator beam. The connector portion may be contiguous with the actuating portion and coupled to the movable body while also extending at least partially back towards the anchor, and being arranged adjacently and spaced apart from the actuating portion.

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays (LCDs), organic light-emitting diode (“OLED”) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

The foregoing discussion will be understood more readily from the following detailed description with reference to the following drawings

FIG. 1A is an isometric view of an example display apparatus;

FIG. 1B is a block diagram of the display apparatus of FIG. 1A;

FIG. 2 is a perspective view of an illustrative shutter-based light modulator suitable for incorporation into the MEMS-based display of FIG. 1A;

FIG. 3A is a schematic diagram of a control matrix suitable for controlling the light modulators incorporated into the MEMS-based display of FIG. 1A;

FIG. 3B is a perspective view of an array of shutter-based light modulators connected to the control matrix of FIG. 3A;

FIGS. 4A and 4B are plan views of a dual-actuated shutter assembly in the open and closed states respectively;

FIG. 5 is a cross-sectional view of a shutter-based display apparatus;

FIG. 6 is a diagram of a shutter assembly having compliant beams connected to a movable shutter;

FIG. 7 is another diagram of a shutter assembly having compliant beams connected to a side of a movable shutter facing away from an axis of a direction of motion;

FIG. 8 is a diagram of a shutter assembly including compliant support beams and bumper elements;

FIG. 9 is another diagram of a shutter assembly including compliant support beams and bumper elements;

FIG. 10 is a flow diagram of a process for manufacturing an electromechanical device including a compliant support beam; and

FIGS. 11A and 11B are system block diagrams illustrating a display device that includes a plurality of light modulator display elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

To provide an overall understanding of the application, certain illustrative implementations will now be described, including systems and methods that enable a compliant support beam to support a movable element or body within an electromechanical device. Systems and methods of the present application enable a compliant support beam to be connected to nearly any portion or location of a movable element (e.g., a shutter), which can reduce the amount of tilt of the movable element and reduce the amount of imparted stress on the movable element to, thereby, enable more efficient movement of the movable element along an direction of motion. As previously discussed, a movable element can be formed in a way that causes a portion of the movable element to tilt above or below a plane in which the movable element moves along a direction of motion. Such tilt can cause the movable element to contact another feature of a MEMS device such as a substrate in proximity with the movable element. I

One approach to addressing the tilt problem is to couple a support beam to the movable element such that the adverse effects of the tilt are minimized or mitigated. In one configuration, a compliant support beam is connected to the movable element at or about a central location of a side of the movable element facing the direction of motion of the movable element. By coupling the compliant support beam to the movable element in this central location, the amount of tilt outside the plane is minimized because the length of the tilt outside the plane including the direction of motion is reduced. By including a loop back segment in the compliant support beam, the compliant support beam is able to extend across an axis of the direction of motion. The compliant support beam may then extend back toward the axis of the direction of motion to enable connection to a desired portion or location of the movable element, including a central location. A support beam may also be referred to as a load beam.

In certain implementations, a compliant support beam is connected to a movable element (e.g., a shutter) along a side of the movable element facing away from, and extending parallel to, the axis of the direction of motion of the movable element. By connecting the compliant support beam to the side of a movable element that extends in a parallel manner to the axis of the direction of motion, the overall length of the compliant support beam can be reduced because the compliant support beam extends a shorter distance back toward the axis of the direction of motion, i.e., the compliant support beam can extend back to the side of the shutter. With a shorter length, the spring constant of the compliant support beam is increased, resulting in faster movement of the movable element. Another advantage to coupling the compliant support beam to a side extending parallel to the axis of the direction of motion is that stress associated with a compliant support beam is not imparted to the movable element, which could deform the movable element, resulting in stiction of degraded performance of the movable element.

While the following detailed description includes examples of electromagnetic devices employed within displays, it will be understood by one having ordinary skill in the art that the systems and methods described herein may be adapted and modified as is appropriate for the application being addressed and that the systems and methods described herein may be employed in other suitable applications, and that such other additions and modifications will not depart from the scope hereof.

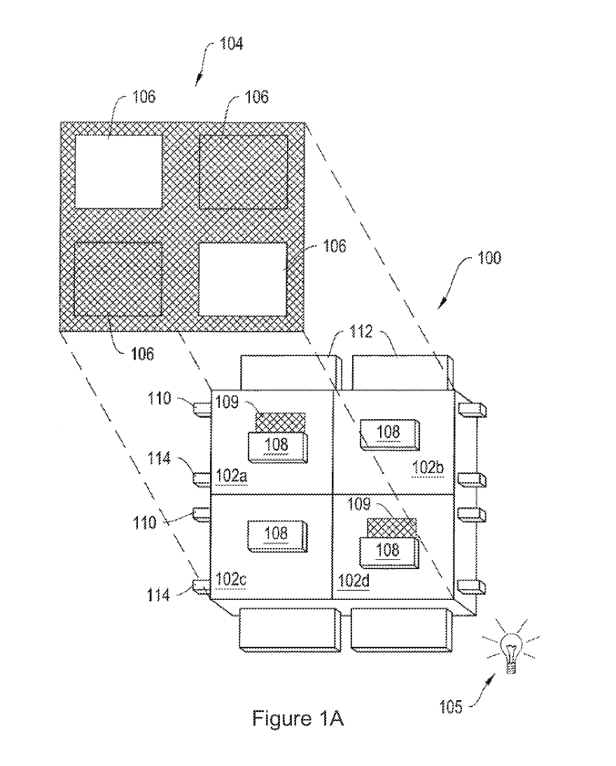

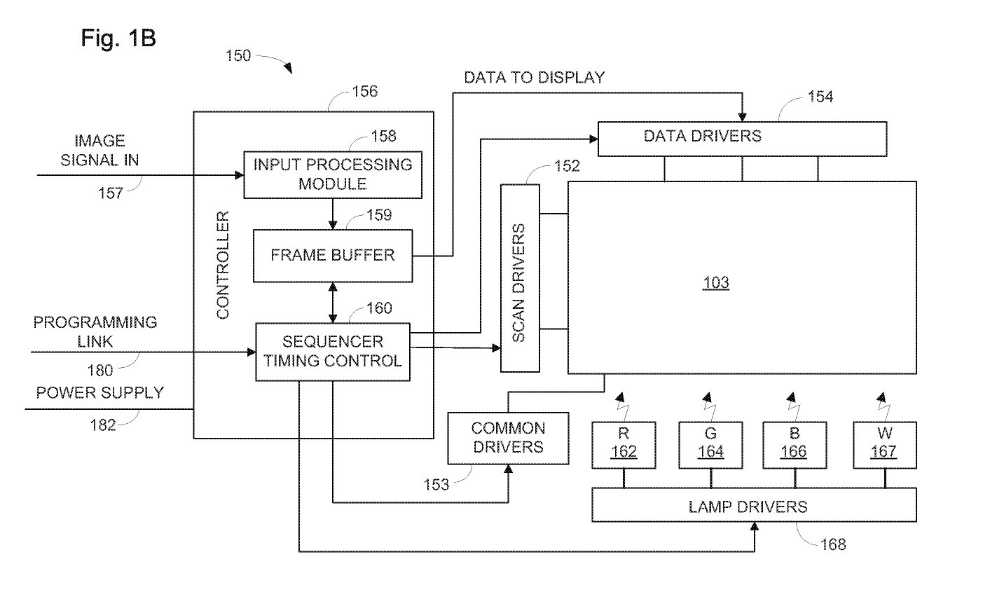

FIG. 1A is a schematic diagram of a direct-view MEMS-based display apparatus 100. The display apparatus 100 includes a plurality of light modulators 102a-102d (generally “light modulators 102”) arranged in rows and columns. In the display apparatus 100, light modulators 102a and 102d are in the open state, allowing light to pass. Light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e. by use of a front light. In one of the closed or open states, the light modulators 102 interfere with light in an optical path by, for example, and without limitation, blocking, reflecting, absorbing, filtering, polarizing, diffracting, or otherwise altering a property or path of the light.

In the display apparatus 100, each light modulator 102 corresponds to a pixel 106 in the image 104. In other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide grayscale in an image 104. With respect to an image, a “pixel” corresponds to the smallest picture element defined by the resolution of the image. With respect to structural components of the display apparatus 100, the term “pixel” refers to the combined mechanical and electrical components utilized to modulate the light that forms a single pixel of the image.

Display apparatus 100 is a direct-view display in that it does not require imaging optics. The user sees an image by looking directly at the display apparatus 100. In alternate implementations, the display apparatus 100 is incorporated into a projection display. In such implementations, the display forms an image by projecting light onto a screen or onto a wall. In projection applications, the display apparatus 100 is substantially smaller than the projected image 104.

Direct-view displays may operate in either a transmissive or reflective mode. In a transmissive display, the light modulators filter or selectively block light which originates from a lamp or lamps positioned behind the display. The light from the lamps is optionally injected into a light guide or “backlight”. Transmissive direct-view display implementations are often built onto transparent or glass substrates to facilitate a sandwich assembly arrangement where one substrate, containing the light modulators, is positioned directly on top of the backlight. In some transmissive display implementations, a color-specific light modulator is created by associating a color filter material with each modulator 102. In other transmissive display implementations, colors can be generated, as described below, using a field sequential color method by alternating illumination of lamps with different primary colors.

Each light modulator 102 includes a shutter 108 and an aperture 109. To illuminate a pixel 106 in the image 104, the shutter 108 is positioned such that it allows light to pass through the aperture 109 towards a viewer. To keep a pixel 106 unlit, the shutter 108 is positioned such that it obstructs the passage of light through the aperture 109. The aperture 109 is defined by an opening patterned through a reflective or light-absorbing material.

The display apparatus also includes a control matrix connected to the substrate and to the light modulators for controlling the movement of the shutters. The control matrix includes a series of electrical interconnects (e.g., interconnects 110, 112, and 114), including at least one write-enable interconnect 110 (also referred to as a “scan-line interconnect”) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the “write-enabling voltage, V_{we}”), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In other implementations, the data voltage pulses control switches, e.g., transistors or other non-linear circuit elements that control the application of separate actuation voltages, which are typically higher in magnitude than the data voltages, to the light modulators 102. The application of these actuation voltages then results in the electrostatic driven movement of the shutters 108.

FIG. 1B is a block diagram 150 of the display apparatus 100. Referring to FIGS. 1A and 1B, in addition to the elements of the display apparatus 100 described above, as depicted in the block diagram 150, the display apparatus 100 includes a plurality of scan drivers 152 (also referred to as “write enabling voltage sources”) and a plurality of data drivers 154 (also referred to as “data voltage sources”). The scan drivers 152 apply write enabling voltages to scan-line interconnects 110. The data drivers 154 apply data voltages to the data interconnects 112. In some implementations of the display apparatus, the data drivers 154 are configured to provide analog data voltages to the light modulators, especially where the gray scale of the image 104 is to be derived in analog fashion. In analog operation the light modulators 102 are designed such that when a range of intermediate voltages is applied through the data interconnects 112 there results a range of intermediate open states in the shutters 108 and therefore a range of intermediate illumination states or gray scales in the image 104.

In other cases the data drivers 154 are configured to apply only a reduced set of 2, 3, or 4 digital voltage levels to the control matrix. These voltage levels are designed to set, in digital fashion, either an open state or a closed state to each of the shutters 108.

The scan drivers 152 and the data drivers 154 are connected to digital controller circuit 156 (also referred to as the “controller 156”). The controller 156 includes an input processing module 158, which processes an incoming image signal 157 into a digital image format appropriate to the spatial addressing and the gray scale capabilities of the display 100. The pixel location and gray scale data of each image is stored in a frame buffer 159 so that the data can be fed out as needed to the data drivers 154. The data is sent to the data drivers 154 in mostly serial fashion, organized in predetermined sequences grouped by rows and by image frames. The data drivers 154 can include series to parallel data converters, level shifting, and for some applications digital to analog voltage converters.

The display 100 apparatus optionally includes a set of common drivers 153, also referred to as common voltage sources. In some implementations the common drivers 153 provide a DC common potential to all light modulators within the array of light modulators 103, for instance by supplying voltage to a series of common interconnects 114. In other implementations the common drivers 153, following commands from the controller 156, issue voltage pulses or signals to the array of light modulators 103, for instance global actuation pulses which are capable of driving or initiating simultaneous actuation of all light modulators in multiple rows and columns of the array 103.

All of the drivers (e.g., scan drivers 152, data drivers 154, and common drivers 153) for different display functions are time-synchronized by a timing-control module 160 in the controller 156. Timing commands from the module 160 coordinate the illumination of red, green and blue and white lamps (162, 164, 166, and 167 respectively) via lamp drivers 168, the write-enabling and sequencing of specific rows within the array of pixels 103, the output of voltages from the data drivers 154, and the output of voltages that provide for light modulator actuation.

The controller 156 determines the sequencing or addressing scheme by which each of the shutters 108 in the array 103 can be re-set to the illumination levels appropriate to a new image 104. New images 104 can be set at periodic intervals. For instance, for video displays, the color images 104 or frames of video are refreshed at frequencies ranging from 10 to 300 Hertz. In some implementations, the setting of an image frame to the array 103 is synchronized with the illumination of the lamps 162, 164, and 166 such that alternate image frames are illuminated with an alternating series of colors, such as red, green, and blue. The image frames for each respective color is referred to as a color sub-frame. In this method, referred to as the field sequential color method, if the color sub-frames are alternated at frequencies in excess of 20 Hz, the human brain will average the alternating frame images into the perception of an image having a broad and continuous range of colors. In alternate implementations, four or more lamps with primary colors can be employed in display apparatus 100, employing primaries other than red, green, and blue.

In some implementations, where the display apparatus 100 is designed for the digital switching of shutters 108 between open and closed states, the controller 156 determines the addressing sequence and the time intervals between image frames to produce images 104 with appropriate gray scale. The process of generating varying levels of grayscale by controlling the amount of time a shutter 108 is open in a particular frame is referred to as time division gray scale. In some implementations of time division gray scale, the controller 156 determines the time period or the fraction of time within each frame that a shutter 108 is allowed to remain in the open state, according to the illumination level or gray scale desired of that pixel. In other implementations, for each image frame, the controller 156 sets a plurality of sub-frame images in multiple rows and columns of the array 103, and the controller alters the duration over which each sub-frame image is illuminated in proportion to a gray scale value or significance value employed within a coded word for gray scale. For instance, the illumination times for a series of sub-frame images can be varied in proportion to the binary coding series 1, 2, 4, 8 . . . . The shutters 108 for each pixel in the array 103 are then set to either the open or closed state within a sub-frame image according to the value at a corresponding position within the pixel's binary coded word for gray level.

In other implementations, the controller alters the intensity of light from the lamps 162, 164, and 166 in proportion to the gray scale value desired for a particular sub-frame image. A number of hybrid techniques are also available for forming colors and gray scale from an array of shutters 108. For instance, the time division techniques described above can be combined with the use of multiple shutters 108 per pixel, or the gray scale value for a particular sub-frame image can be established through a combination of both sub-frame timing and lamp intensity.

In some implementations, the data for an image state 104 is loaded by the controller 156 to the modulator array 103 by a sequential addressing of individual rows, also referred to as scan lines. For each row or scan line in the sequence, the scan driver 152 applies a write-enable voltage to the write enable interconnect 110 for that row of the array 103, and subsequently the data driver 154 supplies data voltages, corresponding to desired shutter states, for each column in the selected row. This process repeats until data has been loaded for all rows in the array. In some implementations the sequence of selected rows for data loading is linear, proceeding from top to bottom in the array. In other implementations, the sequence of selected rows is pseudo-randomized, in order to minimize visual artifacts. In further implementations, the sequencing is organized by blocks, where, for a block, the data for only a certain fraction of the image state 104 is loaded to the array, for instance by addressing only every 5^{th} row of the array in sequence.

In some implementations, the process for loading image data to the array 103 is separated in time from the process of actuating the shutters 108. In these implementations, the modulator array 103 may include data memory elements for each pixel in the array 103 and the control matrix may include a global actuation interconnect for carrying trigger signals, from common driver 153, to initiate simultaneous actuation of shutters 108 according to data stored in the memory elements. Various addressing sequences, many of which are described in U.S. patent application Ser. No. 11/643,042, can be coordinated by means of the timing control module 160.

In alternative implementations, the array of pixels 103 and the control matrix that controls the pixels may be arranged in configurations other than rectangular rows and columns. For example, the pixels can be arranged in hexagonal arrays or curvilinear rows and columns. In general, as used herein, the term scan-line shall refer to any plurality of pixels that share a write-enabling interconnect.

The display 100 includes of a plurality of functional blocks including the timing control module 160, the frame buffer 159, scan drivers 152, data drivers 154, and drivers 153 and 168. Each block can be understood to represent either a distinguishable hardware circuit or a module of executable code. In some implementations, the functional blocks are provided as distinct chips or circuits connected together by means of circuit boards or cables. Alternately, many of these circuits can be fabricated along with the pixel array 103 on the same substrate of glass or plastic. In other implementations, multiple circuits, drivers, processors, or control functions from block diagram 150 may be integrated together within a single silicon chip, which is then bonded directly to the transparent substrate holding pixel array 103.

The controller 156 includes a programming link 180 by which the addressing, color, or gray scale algorithms, which are implemented within controller 156, can be altered according to the needs of particular applications. In some implementations, the programming link 180 conveys information from environmental sensors, such as ambient light or temperature sensors, so that the controller 156 can adjust imaging modes or backlight power in correspondence with environmental conditions. The controller 156 also includes a power supply input 182 which provides the power needed for lamps as well as light modulator actuation. Where necessary, the drivers 152, 153, 154, and 168 may include or be associated with DC-DC converters for transforming an input voltage at 182 into various voltages sufficient for the actuation of shutters 108 or illumination of the lamps, such as lamps 162, 164, 166, and 167.

MEMS Light Modulators

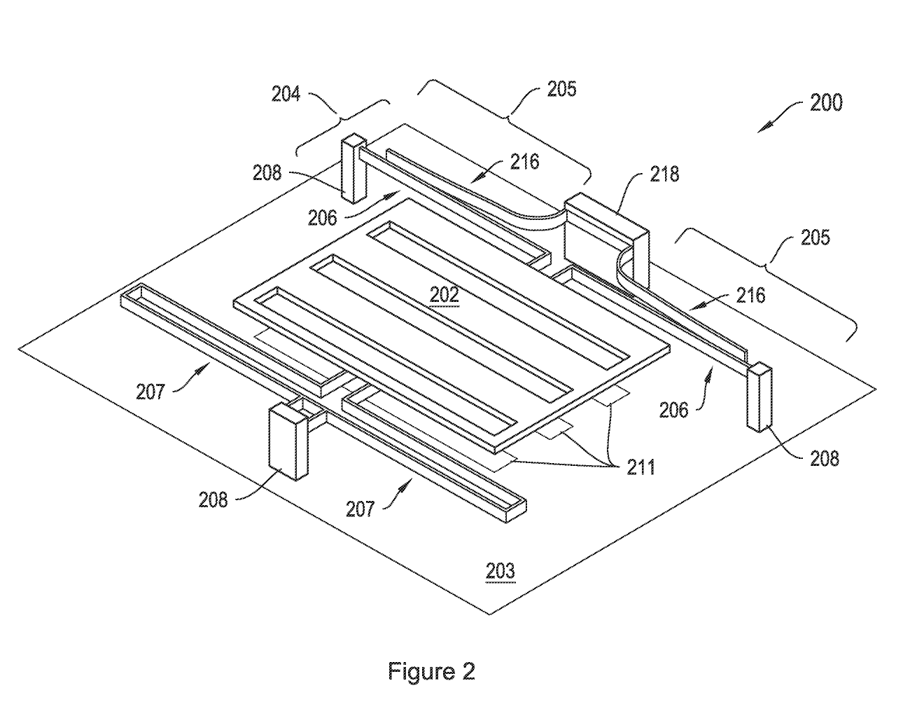

FIG. 2 is a perspective view of an illustrative shutter-based light modulator 200 suitable for incorporation into the MEMS-based display apparatus 100 of FIG. 1A. The shutter-based light modulator 200 (also referred to as shutter assembly 200) includes a shutter 202 coupled to an actuator 204. The actuator 204 is formed from two separate compliant electrode beam actuators 205 (the “actuators 205”) The shutter 202 couples on one side to the actuators 205. The actuators 205 move the shutter 202 transversely over a surface 203 in a plane of motion which is substantially parallel to the surface 203. The opposite side of the shutter 202 couples to a spring 207 which provides a restoring force opposing the forces exerted by the actuator 204.

Each actuator 205 includes a compliant load beam 206 connecting the shutter 202 to a load anchor 208. The load anchors 208 along with the compliant load beams 206 serve as mechanical supports, keeping the shutter 202 suspended proximate to the surface 203. The load anchors 208 physically connect the compliant load beams 206 and the shutter 202 to the surface 203 and electrically connect the load beams 206 to a bias voltage, in some instances, ground.

Each actuator 205 also includes a compliant drive beam 216 positioned adjacent to each load beam 206. The drive beams 216 couple at one end to a drive beam anchor 218 shared between the drive beams 216. The other end of each drive beam 216 is free to move. Each drive beam 216 is curved such that it is closest to the load beam 206 near the free end of the drive beam 216 and the anchored end of the load beam 206.

The surface 203 includes one or more apertures 211 for admitting the passage of light. If the shutter assembly 200 is formed on an opaque substrate, made for example from silicon, then the surface 203 is a surface of the substrate, and the apertures 211 are formed by etching an array of holes through the substrate. If the shutter assembly 200 is formed on a transparent substrate, made for example of glass or plastic, then the surface 203 is a surface of a light blocking layer deposited on the substrate, and the apertures are formed by etching the surface 203 into an array of holes 211. The apertures 211 can be generally circular, elliptical, polygonal, serpentine, or irregular in shape.

In operation, a display apparatus incorporating the light modulator 200 applies an electric potential to the drive beams 216 via the drive beam anchor 218. A second electric potential may be applied to the load beams 206. The resulting potential difference between the drive beams 216 and the load beams 206 pulls the free ends of the drive beams 216 towards the anchored ends of the load beams 206, and pulls the shutter ends of the load beams 206 toward the anchored ends of the drive beams 216, thereby driving the shutter 202 transversely towards the drive anchor 218. The compliant members 206 act as springs, such that when the voltage across the beams 206 and 216 is removed, the load beams 206 push the shutter 202 back into its initial position, releasing the stress stored in the load beams 206.

The shutter assembly 200, also referred to as an elastic shutter assembly, incorporates a passive restoring force, such as a spring, for returning a shutter to its rest or relaxed position after voltages have been removed. A number of elastic restore mechanisms and various electrostatic couplings can be designed into or in conjunction with electrostatic actuators, the compliant beams illustrated in shutter assembly 200 being just one example. For instance, a highly non-linear voltage-displacement response can be provided which favors an abrupt transition between “open” vs. “closed” states of operation, and which, in many cases, provides a bi-stable or hysteretic operating characteristic for the shutter assembly. Other electrostatic actuators can be designed with more incremental voltage-displacement responses and with considerably reduced hysteresis, as may be used for analog gray scale operation.

The actuator 205 within the elastic shutter assembly is said to operate between a closed or actuated position and a relaxed position. The designer, however, can choose to place apertures 211 such that shutter assembly 200 is in either the “open” state, i.e. passing light, or in the “closed” state, i.e. blocking light, whenever actuator 205 is in its relaxed position. For illustrative purposes, it is assumed below that elastic shutter assemblies described herein are designed to be open in their relaxed state.

In many cases, a dual set of “open” and “closed” actuators may be provided as part of a shutter assembly so that the control electronics are capable of electrostatically driving the shutters into each of the open and closed states.

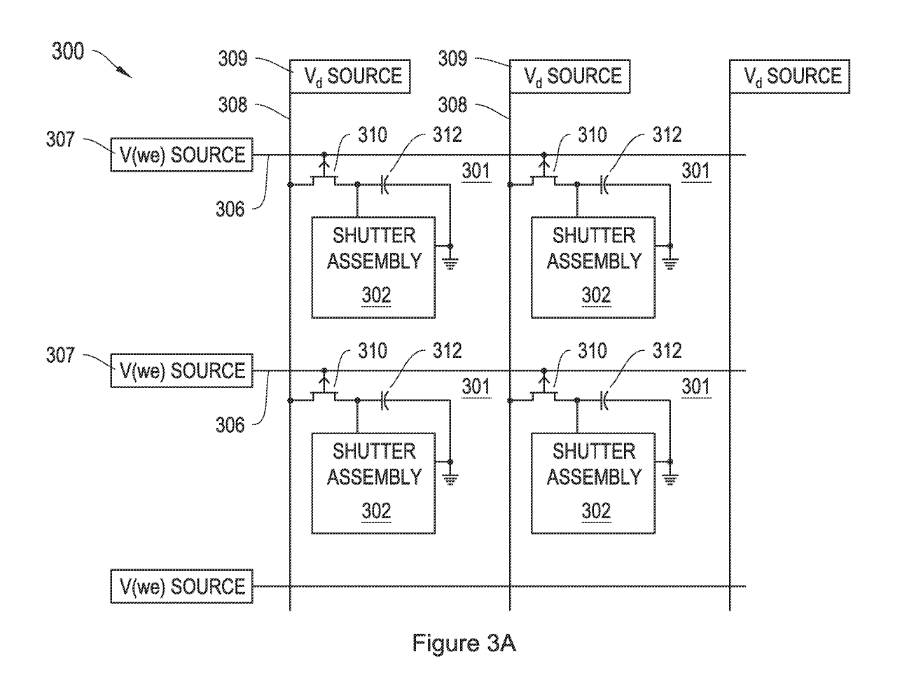

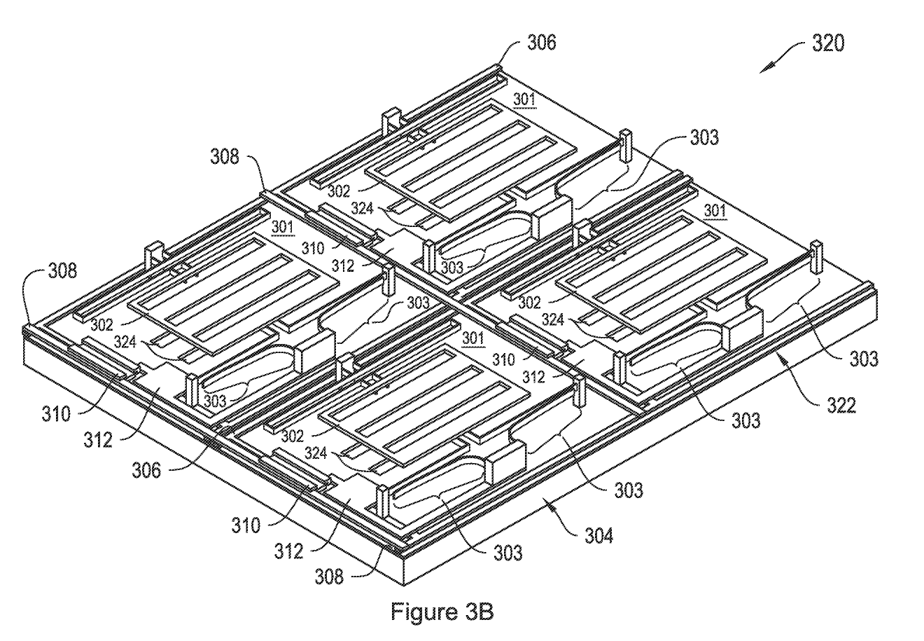

FIG. 3A is a schematic diagram of a control matrix 300 suitable for controlling the light modulators incorporated into the MEMS-based display apparatus 100 of FIG. 1A. FIG. 3B is a perspective view of an array 320 of shutter-based light modulators connected to the control matrix 300 of FIG. 3A. The control matrix 300 may address an array of pixels 320 (the “array 320”). Each pixel 301 includes an elastic shutter assembly 302, such as the shutter assembly 200 of FIG. 2A, controlled by an actuator 303. Each pixel also includes an aperture layer 322 that includes apertures 324.

The control matrix 300 may be fabricated as a diffused or thin-film-deposited electrical circuit on the surface of a substrate 304 on which the shutter assemblies 302 are formed. The control matrix 300 may include a scan-line interconnect 306 for each row of pixels 301 in the control matrix 300 and a data-interconnect 308 for each column of pixels 301 in the control matrix 300. Each scan-line interconnect 306 electrically connects a write-enabling voltage source 307 to the pixels 301 in a corresponding row of pixels 301. Each data interconnect 308 electrically connects a data voltage source, (“Vd source”) 309 to the pixels 301 in a corresponding column of pixels 301. In control matrix 300, the data voltage V_{d} provides the majority of the energy necessary for actuation of the shutter assemblies 302. Thus, the data voltage source 309 also serves as an actuation voltage source.

FIG. 3B is a perspective view of an array of shutter-based light modulators connected to the control matrix of FIG. 3A. Referring to FIGS. 3A and 3B, for each pixel 301 or for each shutter assembly 302 in the array of pixels 320, the control matrix 300 includes a transistor 310 and a capacitor 312. The gate of each transistor 310 is electrically connected to the scan-line interconnect 306 of the row in the array 320 in which the pixel 301 is located. The source of each transistor 310 is electrically connected to its corresponding data interconnect 308. The actuators 303 of each shutter assembly 302 include two electrodes. The drain of each transistor 310 is electrically connected in parallel to one electrode of the corresponding capacitor 312 and to one of the electrodes of the corresponding actuator 303. The other electrode of the capacitor 312 and the other electrode of the actuator 303 in shutter assembly 302 are connected to a common or ground potential. In alternate implementations, the transistors 310 can be replaced with semiconductor diodes and or metal-insulator-metal sandwich type switching elements.

In operation, to form an image, the control matrix 300 write-enables each row in the array 320 in a sequence by applying V_{we} to each scan-line interconnect 306 in turn. For a write-enabled row, the application of V_{we} to the gates of the transistors 310 of the pixels 301 in the row allows the flow of current through the data interconnects 308 through the transistors 310 to apply a potential to the actuator 303 of the shutter assembly 302. While the row is write-enabled, data voltages V_{d} are selectively applied to the data interconnects 308. In implementations providing analog gray scale, the data voltage applied to each data interconnect 308 is varied in relation to the desired brightness of the pixel 301 located at the intersection of the write-enabled scan-line interconnect 306 and the data interconnect 308.

In implementations providing digital control schemes, the data voltage is selected to be either a relatively low magnitude voltage (i.e., a voltage near ground) or to meet or exceed Vₐₜ (the actuation threshold voltage). In response to the application of Vₐₜ to a data interconnect 308, the actuator 303 in the corresponding shutter assembly 302 actuates, opening the shutter in that shutter assembly 302. The voltage applied to the data interconnect 308 remains stored in the capacitor 312 of the pixel 301 even after the control matrix 300 ceases to apply V_{we} to a row. It is not necessary, therefore, to wait and hold the voltage V_{we} on a row for times long enough for the shutter assembly 302 to actuate; such actuation can proceed after the write-enabling voltage has been removed from the row. The capacitors 312 also function as memory elements within the array 320, storing actuation instructions for periods as long as is necessary for the illumination of an image frame.

The pixels 301 as well as the control matrix 300 of the array 320 are formed on a substrate 304. The array includes an aperture layer 322, disposed on the substrate 304, which includes a set of apertures 324 for respective pixels 301 in the array 320. The apertures 324 are aligned with the shutter assemblies 302 in each pixel. In one implementation the substrate 304 is made of a transparent material, such as glass or plastic. In another implementation the substrate 304 is made of an opaque material, but in which holes are etched to form the apertures 324.

Components of shutter assemblies 302 are processed either at the same time as the control matrix 300 or in subsequent processing steps on the same substrate. The electrical components in control matrix 300 are fabricated using many thin film techniques in common with the manufacture of thin film transistor arrays for liquid crystal displays. Available techniques are described in Den Boer, Active Matrix Liquid Crystal Displays (Elsevier, Amsterdam, 2005), the entirety of which is incorporated herein by reference. The shutter assemblies are fabricated using techniques similar to the art of micromachining or from the manufacture of micromechanical (i.e., MEMS) devices. Many applicable thin film MEMS techniques are described in Rai-Choudhury, ed., Handbook of Microlithography, Micromachining & Microfabrication (SPIE Optical Engineering Press, Bellingham, Wash. 1997), the entirety of which is incorporated herein by reference. For instance, the shutter assembly 302 can be formed from thin films of amorphous silicon, deposited by a chemical vapor deposition process.

The shutter assembly 302 together with the actuator 303 can be made bi-stable. That is, the shutters can exist in at least two equilibrium positions (e.g. open or closed) with little or no power required to hold them in either position. More particularly, the shutter assembly 302 can be mechanically bi-stable. Once the shutter of the shutter assembly 302 is set in position, no electrical energy or holding voltage is required to maintain that position. The mechanical stresses on the physical elements of the shutter assembly 302 can hold the shutter in place.

The shutter assembly 302 together with the actuator 303 can also be made electrically bi-stable. In an electrically bi-stable shutter assembly, there exists a range of voltages below the actuation voltage of the shutter assembly, which if applied to a closed actuator (with the shutter being either open or closed), holds the actuator closed and the shutter in position, even if an opposing force is exerted on the shutter. The opposing force may be exerted by a spring such as spring 207 in shutter-based light modulator 200, or the opposing force may be exerted by an opposing actuator, such as an “open” or “closed” actuator.

The light modulator array 320 is depicted as having a single MEMS light modulator per pixel. Other implementations are possible in which multiple MEMS light modulators are provided in each pixel, thereby providing the possibility of more than just binary “on’ or “off” optical states in each pixel. Certain forms of coded area division gray scale are possible where multiple MEMS light modulators in the pixel are provided, and where apertures 324, which are associated with each of the light modulators, have unequal areas.

In other implementations, the roller-based light modulator 220, the light tap 250, or the electrowetting-based light modulation array 270, as well as other MEMS-based light modulators, can be substituted for the shutter assembly 302 within the light modulator array 320.

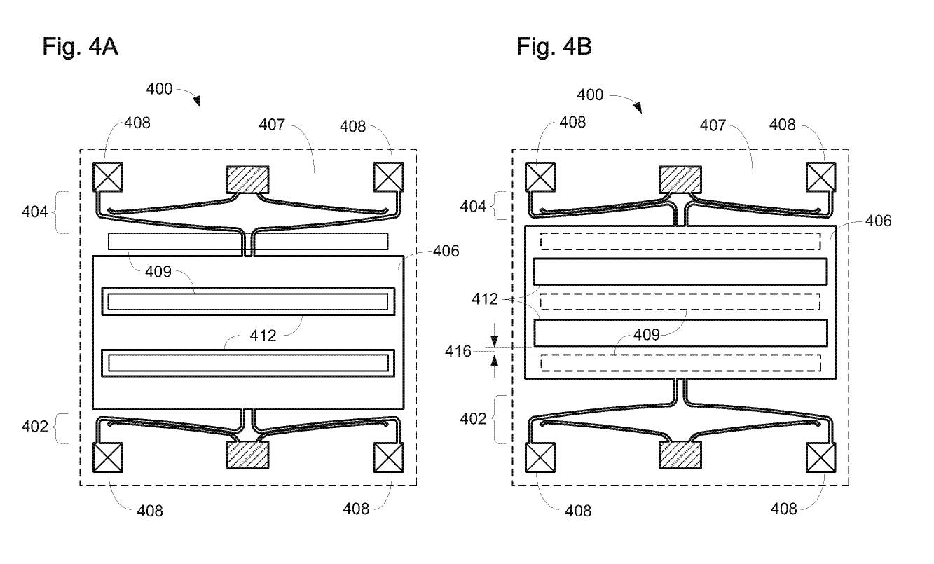

FIGS. 4A and 4B illustrate an alternative shutter-based light modulator (shutter assembly) 400 suitable for inclusion in various implementations. The light modulator 400 is an example of a dual actuator shutter assembly, and is shown in FIG. 4A in an open state. FIG. 4B is a view of the dual actuator shutter assembly 400 in a closed state. In contrast to the shutter assembly 200, shutter assembly 400 includes actuators 402 and 404 on either side of a shutter 406. Each actuator 402 and 404 is independently controlled. A first actuator, a shutter-open actuator 402, serves to open the shutter 406. A second opposing actuator, the shutter-close actuator 404, serves to close the shutter 406. Both actuators 402 and 404 are compliant beam electrode actuators. The actuators 402 and 404 open and close the shutter 406 by driving the shutter 406 substantially in a plane parallel to an aperture layer 407 over which the shutter is suspended. The shutter 406 is suspended a short distance over the aperture layer 407 by anchors 408 attached to the actuators 402 and 404. The inclusion of supports attached to both ends of the shutter 406 along its axis of a direction of motion reduces out of plane motion of the shutter 406 and confines the motion substantially to a plane parallel to the substrate. By analogy to the control matrix 300 of FIG. 3A, a control matrix suitable for use with shutter assembly 400 might include one transistor and one capacitor for each of the opposing shutter-open and shutter-close actuators 402 and 404.

The shutter 406 includes two shutter apertures 412 through which light can pass. The aperture layer 407 includes a set of three apertures 409. In FIG. 4A, the shutter assembly 400 is in the open state and, as such, the shutter-open actuator 402 has been actuated, the shutter-close actuator 404 is in its relaxed position, and the centerlines of apertures 412 and 409 coincide. In FIG. 4B the shutter assembly 400 has been moved to the closed state and, as such, the shutter-open actuator 402 is in its relaxed position, the shutter-close actuator 404 has been actuated, and the light blocking portions of shutter 406 are now in position to block transmission of light through the apertures 409 (shown as dotted lines).

Each aperture has at least one edge around its periphery. For example, the rectangular apertures 409 have four edges. In alternative implementations in which circular, elliptical, oval, or other curved apertures are formed in the aperture layer 407, each aperture may have only a single edge. In other implementations the apertures need not be separated or disjoint in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through apertures 412 and 409 in the open state, it is advantageous to provide a width or size for shutter apertures 412 which is larger than a corresponding width or size of apertures 409 in the aperture layer 407. In order to effectively block light from escaping in the closed state, the light blocking portions of the shutter 406 may be arranged to overlap the apertures 409. FIG. 4B shows a predefined overlap 416 between the edge of light blocking portions in the shutter 406 and one edge of the aperture 409 formed in aperture layer 407.

The electrostatic actuators 402 and 404 are designed so that their voltage-displacement behavior provides a bi-stable characteristic to the shutter assembly 400. For each of the shutter-open and shutter-close actuators there exists a range of voltages below the actuation voltage, which if applied while that actuator is in the closed state (with the shutter being either open or closed), will hold the actuator closed and the shutter in position, even after an actuation voltage is applied to the opposing actuator. The minimum voltage needed to maintain a shutter's position against such an opposing force is referred to as a maintenance voltage Vₘ.

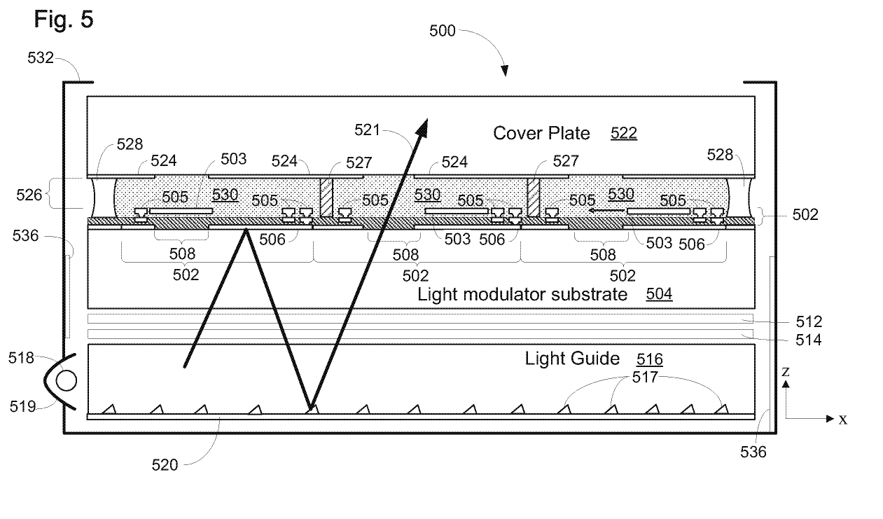

FIG. 5 is a cross sectional view of a display apparatus 500 incorporating shutter-based light modulators (shutter assemblies) 502. Each shutter assembly incorporates a shutter 503 and an anchor 505. Not shown are the compliant beam actuators which, when connected between the anchors 505 and the shutters 503, help to suspend the shutters a short distance above the surface. The shutter assemblies 502 are disposed on a transparent substrate 504, and may be made of plastic or glass. A rear-facing reflective layer, reflective film 506, disposed on the substrate 504 defines a plurality of surface apertures 508 located beneath the closed positions of the shutters 503 of the shutter assemblies 502. The reflective film 506 reflects light not passing through the surface apertures 508 back towards the rear of the display apparatus 500. The reflective aperture layer 506 can be a fine-grained metal film without inclusions formed in thin film fashion by a number of vapor deposition techniques including sputtering, evaporation, ion plating, laser ablation, or chemical vapor deposition. In another implementation, the rear-facing reflective layer 506 can be formed from a mirror, such as a dielectric mirror. A dielectric mirror is fabricated as a stack of dielectric thin films which alternate between materials of high and low refractive index. The vertical gap which separates the shutters 503 from the reflective film 506, within which the shutter is free to move, is in the range of 0.5 to 10 microns. The magnitude of the vertical gap may be less than the lateral overlap between the edge of shutters 503 and the edge of apertures 508 in the closed state, such as the overlap 416 shown in FIG. 4B.

The display apparatus 500 includes an optional diffuser 512, an optional brightness enhancing film 514, or combination thereof, which separates the substrate 504 from a planar light guide 516. The light guide includes a transparent, i.e. glass or plastic material. The light guide 516 is illuminated by one or more light sources 518, forming a backlight. The light sources 518 can be, for example, and without limitation, incandescent lamps, fluorescent lamps, lasers, or light emitting diodes (LEDs). A reflector 519 helps direct light from lamp 518 towards the light guide 516. A front-facing reflective film 520 is disposed behind the backlight 516, reflecting light towards the shutter assemblies 502. Light rays such as ray 521 from the backlight that do not pass through one of the shutter assemblies 502 will be returned to the backlight and reflected again from the film 520. In this fashion light that fails to leave the display to form an image on the first pass can be recycled and made available for transmission through other open apertures in the array of shutter assemblies 502. Such light recycling has been shown to increase the illumination efficiency of the display.

The light guide 516 includes a set of geometric light redirectors or prisms 517 which re-direct light from the lamps 518 towards the apertures 508 and hence toward the front of the display. The light re-directors can be molded into the plastic body of light guide 516 with shapes that can be alternately triangular, trapezoidal, or curved in cross section. The density of the prisms 517 generally increases with distance from the lamp 518.

In alternate implementations, the aperture layer 506 can be made of a light absorbing material, and in alternate implementations the surfaces of shutter 503 can be coated with either a light absorbing or a light reflecting material. In alternate implementations the aperture layer 506 can be deposited directly on the surface of the light guide 516. In alternate implementations the aperture layer 506 need not be disposed on the same substrate as the shutters 503 and anchors 505 (see the MEMS-down configuration described below).

In one implementation, the light sources 518 can include lamps of different colors, for instance, the colors red, green, and blue. A color image can be formed by sequentially illuminating images with lamps of different colors at a rate sufficient for the human brain to average the different colored images into a single multi-color image. The various color-specific images are formed using the array of shutter assemblies 502. In another implementation, the light source 518 includes lamps having more than three different colors. For example, the light source 518 may have red, green, blue and white lamps or red, green, blue, and yellow lamps.

A cover plate 522 forms the front of the display apparatus 500. The rear side of the cover plate 522 can be covered with a black matrix 524 to increase contrast. In alternate implementations the cover plate includes color filters, for instance distinct red, green, and blue filters corresponding to different ones of the shutter assemblies 502. The cover plate 522 is supported a predetermined distance away from the shutter assemblies 502 forming a gap 526. The gap 526 is maintained by mechanical supports, spacers 527, by an adhesive seal 528 attaching the cover plate 522 to the substrate 504, or any combination thereof.

The adhesive seal 528 seals in a working fluid 530. The working fluid 530 is engineered with viscosities that may be below about 10 centipoise and with relative dielectric constant that may be above about 2.0, and dielectric breakdown strengths above about 10⁴ V/cm. The working fluid 530 can also serve as a lubricant. In one implementation, the working fluid 530 is a hydrophobic liquid with a high surface wetting capability. In alternate implementations the working fluid 530 has a refractive index that is either greater than or less than that of the substrate 504.

When the MEMS-based display assembly includes a liquid for the working fluid 530, the liquid at least partially surrounds the moving parts of the MEMS-based light modulator. In order to reduce the actuation voltages, the liquid has a viscosity that may be below 70 centipoise, or even below 10 centipoise. Liquids with viscosities below 70 centipoise can include materials with low molecular weights: below 4000 grams/mole, or in some cases below 400 grams/mole. Suitable working fluids 530 include, without limitation, de-ionized water, methanol, ethanol and other alcohols, paraffins, olefins, ethers, silicone oils, fluorinated silicone oils, or other natural or synthetic solvents or lubricants. Useful working fluids can be polydimethylsiloxanes, such as hexamethyldisiloxane and octamethyltrisiloxane, or alkyl methyl siloxanes such as hexylpentamethyldisiloxane. Useful working fluids can be alkanes, such as octane or decane. Useful fluids can be nitroalkanes, such as nitromethane. Useful fluids can be aromatic compounds, such as toluene or diethylbenzene. Useful fluids can be ketones, such as butanone or methyl isobutyl ketone. Useful fluids can be chlorocarbons, such as chlorobenzene. Useful fluids can be chlorofluorocarbons, such as dichlorofluoroethane or chlorotrifluoroethylene. And other fluids considered for these display assemblies include butyl acetate, dimethylformamide.

For many implementations, it is advantageous to incorporate a mixture of the above fluids. For instance mixtures of alkanes or mixtures of polydimethylsiloxanes can be useful where the mixture includes molecules with a range of molecular weights. It is also possible to optimize properties by mixing fluids from different families or fluids with different properties. For instance, the surface wetting properties of a hexamethyldisiloxane and be combined with the low viscosity of butanone to create an improved fluid.

A sheet metal or molded plastic assembly bracket 532 holds the cover plate 522, the substrate 504, the backlight 516 and the other component parts together around the edges. The assembly bracket 532 is fastened with screws or indent tabs to add rigidity to the combined display apparatus 500. In some implementations, the light source 518 is molded in place by an epoxy potting compound. Reflectors 536 help return light escaping from the edges of light guide 516 back into the light guide. Not shown in FIG. 5 are electrical interconnects which provide control signals as well as power to the shutter assemblies 502 and the lamps 518.

Display apparatus 500 is referred to as the MEMS-up configuration, where the MEMS based light modulators are formed on a front surface of substrate 504, i.e. the surface that faces toward the viewer. The shutter assemblies 502 are built directly on top of the reflective aperture layer 506. In an alternate implementation, referred to as the MEMS-down configuration, the shutter assemblies are disposed on a substrate separate from the substrate on which the reflective aperture layer is formed. The substrate on which the reflective aperture layer is formed, defining a plurality of apertures, is referred to herein as the aperture plate. In the MEMS-down configuration, the substrate that carries the MEMS-based light modulators takes the place of the cover plate 522 in display apparatus 500 and is oriented such that the MEMS-based light modulators are positioned on the rear surface of the top substrate, i.e. the surface that faces away from the viewer and toward the back light 516. The MEMS-based light modulators are thereby positioned directly opposite to and across a gap from the reflective aperture layer. The gap can be maintained by a series of spacer posts connecting the aperture plate and the substrate on which the MEMS modulators are formed. In some implementations, the spacers are disposed within or between each pixel in the array. The gap or distance that separates the MEMS light modulators from their corresponding apertures may be less than 10 microns, or a distance that is less than the overlap between shutters and apertures, such as overlap 416.

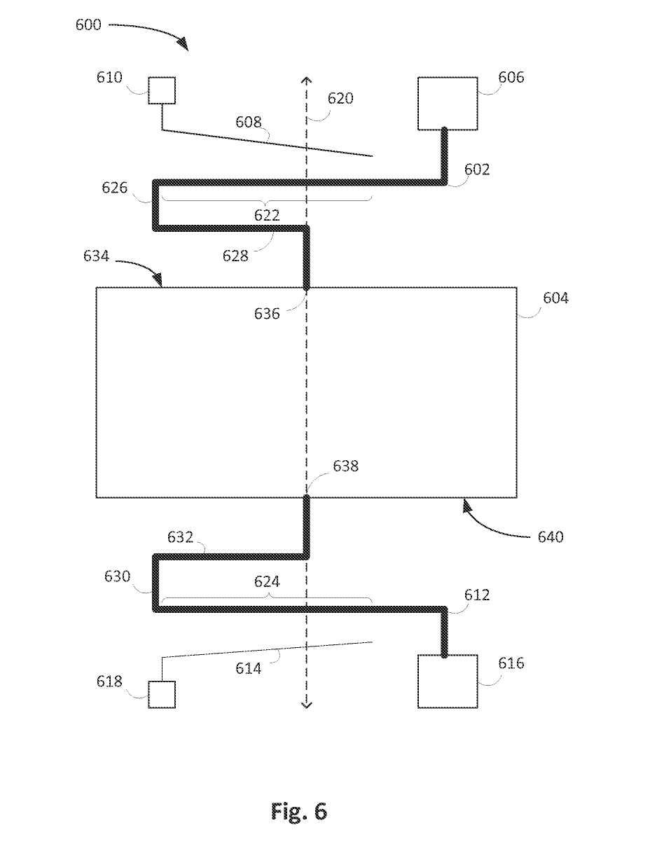

FIG. 6 is a diagram of a shutter assembly 600 having compliant beams 602 and 612 connected to a movable shutter 604. The shutter assembly 600 is a type of electromechanical device used to modulate light for a display as described in further detail with respect to FIGS. 1A-5 herein. The compliant support or load beam 602 is coupled to an anchor 606 at a first end and coupled to the shutter 604 at a second end. The compliant support beam 612 is coupled to an anchor 616 at a first end and coupled to the shutter 604 at a second end. The shutter assembly 600 also includes drive beams 608 and 614 that are coupled to anchors 610 and 618 respectively. The anchors 606, 610, 616, and 618 may be mounted on a substrate such as substrate 504 or 522 of FIG. 5. In some configurations, the anchors 606, 610, 616, and 618 may be coupled to a layer of material adjacent to substrate 504 or 522 such as, for example, layer 506 or 524 respectively. One function of the anchors 606, 610, 616, and 618 is to suspend the beams 602, 608, 612, and 614, and the shutter 604, a distance away from the substrate. By spacing the shutter 604 a distance away from a substrate, the shutter 604 is allowed to move along an axis of a direction of motion 620.

The various elements of the shutter assembly 600 such as the beams, anchors, and shutter may include materials, properties, dimensions, and arrangements of like elements described with respect to FIGS. 1A-5. In certain configurations, the compliant support beam 602 includes an electrode or actuating portion 622 that opposes or is adjacently spaced apart from the drive beam 608. The drive beam 608 also includes an electrode or actuating portion. As discussed in more detail with respect to FIGS. 2, 3A, 4A, and 4B, the drive beam 608 and compliant support or load beam 602 coordinate to function as an actuator to move the shutter 604 along the axis of the direction of motion 620. The compliant support beam 612 includes an electrode or actuating portion 624 that opposes or is adjacently spaced apart from the drive beam 614. The drive beam 614 also includes an electrode or actuating portion. Again, as discussed in more detail with respect to FIGS. 2, 3A, 4A, and 4B, the drive beam 614 and compliant support beam 612 coordinate to function as an actuator to move the shutter 604 along the axis of the direction of motion 620.

The compliant support beam 602 includes a loop back segment 626 that enables the compliant support beam 602 to extend across or traverse to the axis of the direction of motion 620 from the anchor 606 and then extend back towards the axis of the direction of motion 620 and the anchor 606. The loop back segment 626 may also allow the compliant support beam 602 to extend back adjacently with respect to the actuating portion 622. The compliant support beam 602 also includes a connector portion 628 that couples the compliant support beam 602 to the shutter 604. The compliant support beam 612 includes a loop back segment 630 that enables the compliant support beam 612 to extend across and/or traverse to the axis of the direction of motion 620 from the anchor 616 and then extend back towards the axis of the direction of motion 620 and anchor 616. The loop back segment 630 may also allow the compliant support beam 612 to extend back adjacently with respect to the actuating portion 624.

FIG. 6 illustrates the axis of direction of motion 620 as an axis positioned along the center of the shutter 604. However, the illustrated axis of the direction of motion 620 could be positioned along any other axis parallel to the illustrated axis of the direction of motion 620. In some implementations, the loop back segment 626 enables the compliant support beam 602 to intersect the axis of the direction of motion 620 two times. In fact, if the illustrated axis of the direction of motion 620 were shifted toward the loop back segment 626 or the connection position 636 were shifted along the shutter 604 toward the anchors 606 and 616, the compliant support beam 602 would traverse the illustrated axis of the direction of motion 620 two times. FIG. 6 also illustrates how the loop back segment 626 enables the actuator portion 622 to be adjacently spaced apart from the connector portion 628 of the compliant support beam 602. Likewise, FIG. 6 shows how the loop back segment 630 enables the actuator portion 624 to be adjacently spaced apart from the connector portion 632 of the compliant support beam 612.

As mentioned above, the compliant support beam 612 also includes a connector portion 632 that couples the compliant support beam 612 to the shutter 604. The shutter 604 is an example of one type of movable element, body, or component within an electromechanical device. In certain implementations, the compliant support beam 602 connects to the shutter 604 via connector portion 628 at a connection position 636 along a side 634 of the shutter 604 facing, substantially perpendicular to, or normal to, the axis of the direction of motion 602. As shown in FIG. 6, the connection position 636 may be located on the side 634 at a point that intersects the axis of the direction of motion 620. This may also be about the center point of the side 634. However, in other implementations, the connection position 636 may be located at any location along the side 634 of the shutter 604. One advantage of the loop back segment 626 is that it enables the length of the compliant support beam 602 to be adjusted or configured such that the connector portion 628 can be coupled to the shutter 604 at connection position 636 at any location along the side 634 of the shutter 604. Likewise, the compliant support beam 612 may connect to the shutter 604 via connector portion 632 at a connection position 638 along a side 640 of the shutter 604 facing, substantially perpendicular to, or normal to, the axis of the direction of motion 620. As shown in FIG. 6, the connection position 638 may be located on the side 640 at a point that intersects the axis of the direction of motion 620. This may also be about the center point of the side 640. However, in other implementations, the connection position 638 may be located at any location along the side 640 of the shutter 604.

While FIG. 6 shows an implementation having two compliant support beams 602 and 612, in other implementations, a shutter assembly 600 may use one compliant support beam 602 and drive beam 608, or more than two compliant support beams.

In operation with respect to the implementation shown in FIG. 6, movement of the shutter 604 is effected by applying a voltage to the compliant support beam 602 and a voltage to a corresponding actuator or drive beam 608 spaced away from the compliant support beam 602. An electrostatic field between the actuating portion 622 of the compliant support beam 602 and the drive beam 608 generates an attractive force between the actuating portion 622 of the compliant support beam 602 and the drive beam 608, thereby effecting movement of the shutter 604 along the axis of the direction of motion 620 toward the anchor 606. The greater the length of the actuating portion 622, the lower the actuation voltage. The length of the compliant support beam 602 may be limited by the beam's other function, which is to support the shutter 604 relative to an anchor 606. If the shutter 604 only requires a short mechanical support, the length of its actuating portion 622 may be reduced, resulting in higher actuation voltage.

By including a loop back segment 626 in the compliant support beam 602, the compliant support beam 602 can be advantageously connected to the shutter 604 at any position 636 along a side 634 of the shutter 604 without affecting a desired length of the actuating portion 622 of compliant support beam 602. Thus, the compliant support beam 602 can have an actuating portion 622 that extends the full length of the drive beam 608 to achieve the optimal interaction between the compliant support beam 602 and the actuator or drive beam 608. The depicted compliant support beam 602 then curves back around at the loop back segment 626 to connect the compliant support beam 602 to the shutter 604 via the connector portion 628, such as at the central point 636. Thus, both the optimal actuator-support beam interaction and the desired connection location on the shutter are achieved. Depending on the location of the connection position 636, such as at a center position along the side 634 of the shutter 604 facing the axis of the direction of motion 620, the out-of-plane tilt of the shutter 604 may be reduced, resulting in less drag or stiction of the shutter 604 as it moves along the axis of the direction of motion 620.

Compliant support beam 612 operates in a similar manner as the operations described with respect to compliant support beam 602 above. In certain implementations, the actuation functions for compliant support beams 602 and 612 operate in a complementary manner to move the shutter 604 between positions along the axis of the direction of motion 620. The positions may include an open position for allowing light to pass through an adjacent aperture, such as, for example, aperture 508, or a closed position for blocking the passage of light through an adjacent aperture.

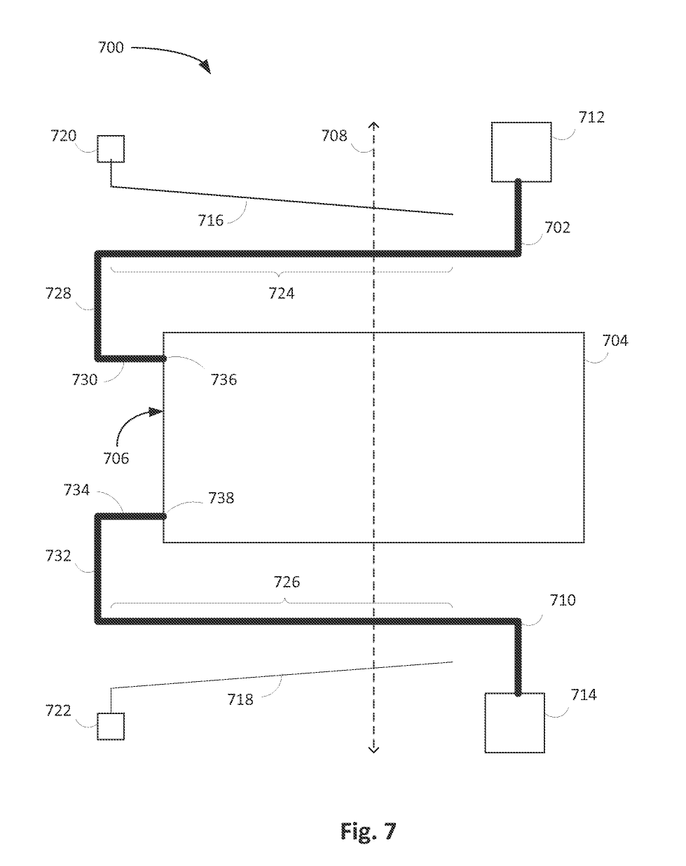

FIG. 7 is another diagram of a shutter assembly 700 having compliant support beams 702 and 710 connected to a side 706 of a movable shutter 704 parallel with an axis of the direction of motion 708 of the shutter 704. The shutter assembly 700 is a type of electromechanical device used to modulate light for a display as described in further detail with respect to FIGS. 1A-6 herein. The compliant support beam 702 is coupled to an anchor 712 at a first end and coupled to the shutter 704 at a second end. The compliant support beam 710 is coupled to an anchor 714 at a first end and coupled to the shutter 704 at a second end. The shutter assembly 700 also includes drives beam 716 and 718 that are coupled to anchors 720 and 722 respectively. The anchors 712, 714, 720, and 722 may be mounted on a substrate such as substrate 504 or 522 of FIG. 5. In some configurations, the anchors 712, 714, 720, and 722 may be coupled to a layer of material adjacent to substrate 504 or 522 such as, for example, layer 506 or 524 respectively. One function of the anchors 712, 714, 720, and 722 is to suspend the beams 702, 710, 716, and 718, and the shutter 704, a distance away from the substrate. By spacing the shutter 704 a distance away from a substrate, the shutter 704 is allowed to move along an axis of the direction of motion 708.

The various elements of the shutter assembly 700 such as the beams, anchors, and shutter may include materials, properties, dimensions, and arrangements of like elements described with respect to FIGS. 1A-6. In certain configurations, the compliant support beam 702 includes an electrode or actuating portion 724 that opposes the drive beam 716. The drive beam 716 also includes an electrode or actuating portion. As discussed in more detail with respect to FIGS. 2, 3A, 4A, and 4B, the drive beam 716 and compliant support beam 702 coordinate to function as an actuator to move the shutter 704 along the axis of the direction of motion 708. The compliant support beam 710 includes an electrode or actuating portion 726 that opposes the drive beam 718. The drive beam 718 also includes an electrode or actuating portion. Again, as discussed in more detail with respect to FIGS. 2, 3A, 4A, and 4B, the drive beam 718 and compliant support beam 710 coordinate to function as an actuator to move the shutter 704 along the axis of the direction of motion 708.

The compliant support beam 702 includes a loop back segment 728 that enables the compliant support beam 702 to extend across or traverse to the axis of the direction of motion 708 from the anchor 712 and then extend back toward the axis of the direction of motion 708. The compliant support beam 702 also includes a connector portion 730 that couples the compliant support beam 702 to the shutter 704. The compliant support beam 710 includes a loop back segment 732 that enables the compliant support beam 710 to extend across or traverse to the axis of the direction of motion 708 from the anchor 714 and then extend back toward the axis of the direction of motion 708. The compliant support beam 710 also includes a connector portion 734 that couples the compliant support beam 710 to the shutter 704. The shutter 704 is an example of one type of movable element, body, or component within an electromechanical device.

In certain implementations, the compliant support beam 702 connects to the shutter 704 via connector portion 730 at a connection position 736 along the side 706 of the shutter 704 facing away from, or extending parallel to, the axis of the direction of motion 708. The connection position 736 may be located at any location along the side 706 of the shutter 704. As previous discussed with respect to FIG. 6, one advantage of the loop back segment 726 is that it enables the length of the compliant support beam 702 to be adjusted or configured such that the connector portion 730 can be coupled to the shutter 704 at connection position 736 at any location along the side 706 of the shutter 704. Likewise, the compliant support beam 710 may connect to the shutter 704 via connector portion 734 at a connection position 738 along the side 706 of the shutter 704 facing away from, or extending parallel to, the axis of the direction of motion 708. The connection position 738 may be located at any location along the side 706 of the shutter 704.

By connecting the compliant support beam 702 or 710 to the side 706, the overall length of the compliant support beam 702 or 710 can be reduced because the compliant support beam 702 or 710 can extend a shorter distance back toward the axis of the direction of motion 708, i.e., the compliant support beam 702 or 710 extends back to the side 706 of the shutter 704. With a shorter length, the spring constant of the compliant support beam 702 or 710 is increased, resulting in faster movement of the shutter 704. By coupling the compliant support beam 702 or 710 to the side 706, the amount of stress on the compliant support beam 702 and/or 710 may be reduced.

In operation with respect to the implementation shown in FIG. 7, movement of the shutter 702 is effected by applying a voltage to the compliant support beam 702 and a voltage to a corresponding actuator or drive beam 716 spaced away from the compliant support beam 702. An electrostatic field between the actuating portion 724 of the compliant support beam 702 and the drive beam 716 generates an attractive force between the actuating portion 724 of the compliant support beam 702 and the drive beam 718, thereby effecting movement of the shutter 704 along the axis of the direction of motion 708 toward the anchor 712. The greater the length of the actuating portion 724 opposing or adjacently spaced apart from the drive beam 716, the greater the attractive force between the actuating portion 724 and the drive beam 716, The length of the compliant support beam 702 may be limited by the beam's other function, which is to support the shutter 704 relative to an anchor 712. If the shutter 704 only requires a short mechanical support, the length of its actuating portion 724 may be reduced, resulting in reduced attractive force. By including a loop back segment 728 in the compliant support beam 702, the length of the actuating portion 724 may be adjusted to maximize the length of the actuating portion 724 opposing the drive beam 716.

Additionally, by including a loop back segment 728 in the compliant support beam 702, the compliant support beam 702 can be advantageously connected to the shutter 704 at any position 736 along the side 706 of the shutter 704 without affecting a desired length of the actuating portion 724 of compliant support beam 702. Thus, the compliant support beam 702 can have an actuating portion 724 that extends the full length of the drive beam 716 to achieve the optimal interaction between the compliant support beam 702 and the actuator or drive beam 716. The depicted compliant support beam 702 can then curve back around at the loop back segment 728 to connect the compliant support beam 702 to the shutter 704 via the connector portion 730. Thus, both the optimal actuator-support beam interaction and the desired connection location on the shutter are achieved.

Compliant support beam 710 operates in a similar manner as the operations described with respect to compliant support beam 702 above. In certain implementations, the actuation functions for compliant support beams 702 and 710 operate in a complementary manner to move the shutter 704 between positions along the axis of the direction of motion 708. The positions may include an open position for allowing light to pass through an adjacent aperture, such as, for example, aperture 508, or a closed position for blocking the passage of light through an adjacent aperture.

While FIGS. 6 and 7 describe configurations where a complaint support beam is connected to a side of a shutter that extends parallel or orthogonal to the axis of the direction of motion, a compliant support beam may be connected to a side of a shutter other than a parallel or orthogonal side, which may depend on the shape or orientation of a shutter. For example, a shutter may have a shape other than rectangular and, therefore, a compliant support beam may be connected to a side or portion of a shutter other than a side or portion of a rectangular shutter. A shutter may be substantially rectangular in shape, but rotated in relation to the axis of the direction of motion. Hence, a compliant support beam may be connected to a side of a shutter facing away from the axis of the direction of motion at an angle greater than about 0 degrees and less than about 90 degrees. Furthermore, a compliant support beam may extend from a side or portion of a shutter substantially orthogonally (e.g., at about a 90 degree angle) or may extend from a side or portion of a shutter at an angle greater than about 0 degrees and less than about 90 degrees.

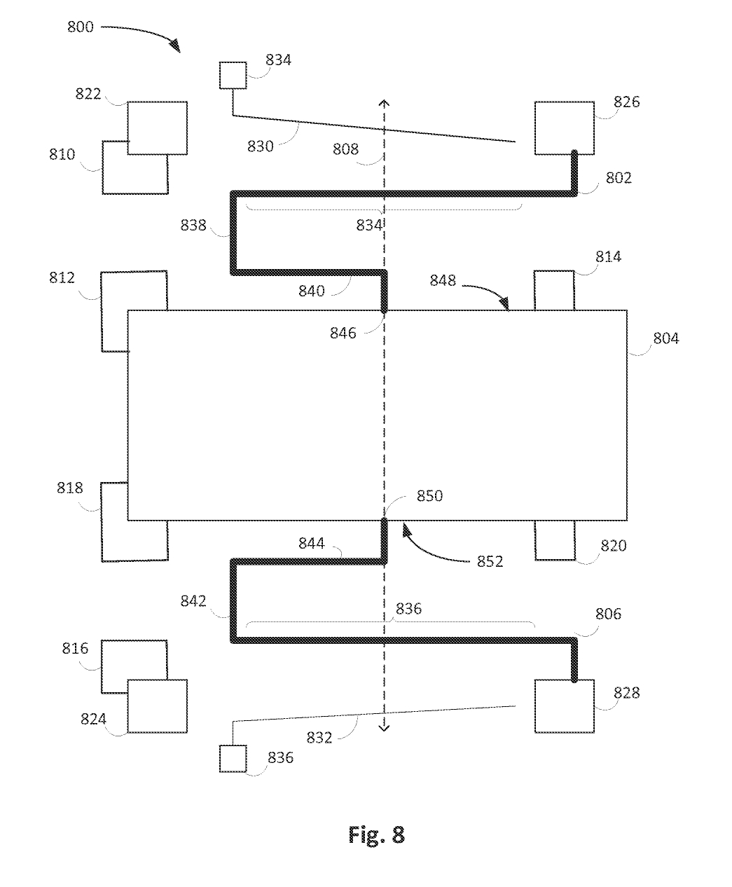

FIG. 8 is a diagram of a shutter assembly 800 including compliant support beams 802 and 806 and bumper elements 810, 812, 814, 816, 818, and 820. In certain implementations, one or more of the bumper elements 812, 814, 818, and 820 are integrally formed with the shutter 804. In some implementations, one or more of the bumper elements 812, 814, 818, and 820 are added to, formed on, or coupled to the shutter 804. One or more of the bumper elements 810 and 816 may be integrally formed with anchors 822 and 824 respectively. One or more of the bumper elements 810 and 816 may be added to, formed on, or coupled to the anchors 822 and 824 respectively. One or more of the bumper elements 810, 812, 814, 816, 818, and 820 may include an electrode.

The shutter assembly 800 is a type of electromechanical device used to modulate light for a display as described in further detail with respect to FIGS. 1A-7 herein. The compliant support beam 802 is coupled to an anchor 826 at a first end and coupled to the shutter 804 at a second end. The compliant support beam 806 is coupled to an anchor 828 at a first end and coupled to the shutter 804 at a second end. The shutter assembly 800 also includes drives beam 830 and 832 that are coupled to anchors 834 and 836 respectively. The bumper elements 810 and 816 are integrally formed within or coupled to anchors 822 and 824. The anchors 822, 824, 826, 828, 834, and 836 may be mounted on a substrate such as substrate 504 or 522 of FIG. 5. In some configurations, the anchors 822, 824, 826, 828, 834, and 836 may be coupled to a layer of material adjacent to substrate 504 or 522 such as, for example, layer 506 or 524 respectively. One function of the anchors 822 and 824 is to suspend the bumper elements 810 and 816 such that the bumper elements 810 and 816 oppose bumper elements 812 and 818 respectively.

The various elements of the shutter assembly 800 such as the beams, anchors, shutter may include the materials, properties, dimensions, and arrangements of like elements described with respect to FIGS. 1A-7, and therefore include similar advantages as previously described herein with respect to FIGS. 1A-7.

In certain implementations, the bumper element 814 functions as a bumper or stop element for the shutter 804 by contacting the compliant support beam 802 and preventing further movement of the shutter 804 in the direction of the anchor 826. The bumper element 820 may also function as a bumper or stop element for the shutter 804 by contacting the compliant support beam 806 and preventing further movement of the shutter 804 in the direction of the anchor 828. The bumper elements 810 and 812 may include electrodes. A voltage differential may be applied between the bumper elements 810 and 812 to generate an electrostatic attractive field to attract the shutter 804 toward the anchor 822 or 826. The electrostatic field may be employed in addition to the actuation process between the compliant support beam 802 and the drive beam 830. Also, the arrangement and size of the bumper elements 810 and 812 may be configured to limit or establish a deterministic amount of travel of the shutter 804 along the axis of the direction of motion 808 in the direction of the anchor 822 or 826 such that the travel of the shutter 804 is stopped when the bumper element 810 contacts the bumper element 812. The bumper elements 816 and 818 may include electrodes and function is a similar manner as described with respect to bumper elements 810 and 812, except that the bumper elements may be configured to limit or establish a deterministic amount of travel of the shutter 804 along the axis of the direction of motion 808 in the direction of the anchor 824 or 828. The arrangement of one or more of the bumper elements 810, 812, 814, 816, 818, and 820 within the shutter assembly 800 provides 1) a deterministic travel for the shutter 804 or 2) an extra hard stop voltage to ensure that the shutter 804 efficiently and properly reaches a desired position. Variations of the shutter assembly 800 may be implemented that include one or more of the bumper elements 810, 812, 814, 816, 818, and 820.

In certain implementations, the bumper elements 810, 812, 814, 816, 818, and 820 are integrally formed with the shutter 804 by forming the shutter and bumper out of the same material layer deposition and photolithography mask, or the bumper elements are made by a separate material layer deposition and photolithography mask. The bumper elements 810, 812, 814, 816, 818, and 820 may include one or more dielectric covering layers to prevent shorting if the bumper elements are used as electrodes. In one implementation, various MEMS elements such as a compliant beam, shutter, or bumper element can be formed from thin films of amorphous silicon, deposited by a chemical vapor deposition process.

Like the compliant load beam 206 and drive beam 216, the bumper elements may be supplied voltages via a control matrix from a controller such as controller 156 of FIG. 1B. As the bumper elements 812, 814, 818, and 820 may be coupled to or formed with the shutter 804, a voltage applied to the shutter 804 via, for example, compliant load beam 802 and anchor 826 may also be applied to bumpers 812, 814, 818, and 820. A voltage may also be applied to bumper elements 810 and 816 via their respective anchors 822 and 824 and a control matrix from a controller such as controller 156. Hence, in addition to driving the actuators for the shutter assembly 800, the controller 156 may control the voltages applied to the bumper elements 810, 816, 812, 814, 818, and 820.

In some implementations, the compliant support beam 802 includes a loop back segment 838 that enables the compliant support beam 802 to extend across or traverse to the axis of the direction of motion 808 from the anchor 826 and then extend back toward the axis of the direction of motion 808. The compliant support beam 802 also includes a connector portion 840 that couples the compliant support beam 802 to the shutter 804. The compliant support beam 806 includes a loop back segment 842 that enables the compliant support beam 806 to extend across or traverse to the axis of the direction of motion 808 from the anchor 828 and then extend back toward the axis of the direction of motion 808. The compliant support beam 806 also includes a connector portion 844 that couples the compliant support beam 806 to the shutter 804. The shutter 804 is an example of one type of movable element, body, or component within an electromechanical device.

In certain implementations, the compliant support beam 802 connects to the shutter 804 via connector portion 840 at a connection position 846 along a side 848 of the shutter 804 facing, substantially perpendicular to, or normal to, the axis of the direction of motion 808. As shown in FIG. 8, the connection position 846 may be located on the side 848 at a point that intersects the axis of the direction of motion 808. This may also be about the center point of the side 848. However, in other implementations, the connection position 846 may be located at any location along the side 848 of the shutter 804. Likewise, the compliant support beam 806 may connect to the shutter 804 via connector portion 844 at a connection position 850 along a side 852 of the shutter 804 facing, substantially perpendicular to, or normal to, the axis of the direction of motion 808. As shown in FIG. 8, the connection position 850 may be located on the side 852 at a point that intersects the axis of the direction of motion 808. This may also be about the center point of the side 852. However, in other implementations, the connection position 850 may be located at any location along the side 852 of the shutter 804.

In operation with respect to the implementation shown in FIG. 8, movement of the shutter 802 is effected by applying a voltage to the compliant support beam 802 and a voltage to a corresponding actuator or drive beam 830 spaced away from the compliant support beam 802. An electrostatic field between the actuating portion 834 of the compliant support beam 802 and the drive beam 830 generates an attractive force between the actuating portion 834 of the compliant support beam 802 and the drive beam 830, thereby effecting movement of the shutter 804 along the axis of the direction of motion 808 toward the anchor 826. The greater the length of the actuating portion 834, the greater the attractive force between the actuating portion 834 and the drive beam 830, resulting in lower pull-in voltage. The length of the compliant support beam 802 may be limited by the beam's other function, which is to support the shutter 804 relative to an anchor 826. If the shutter 804 only requires a short mechanical support, the length of its actuating portion 834 may be reduced, resulting in reduced attractive force.

Additionally, by including a loop back segment 838 in the compliant support beam 802, the compliant support beam 802 can be advantageously connected to the shutter 804 at any position 846 along a side 848 of the shutter 804 without affecting a desired length of the actuating portion 834 of compliant support beam 802. The depicted compliant support beam 802 can then curve back around at the loop back segment 838 to connect the compliant support beam 802 to the shutter 804 via the connector portion 840, such as at the central point 846. Thus, the desired connection location on the shutter is achieved. Depending on the location of the connection position 846, such as at a center position along the side 848 of the shutter 804 facing the axis of the direction of motion 808, the out-of-plane tilt of the shutter 804 may be reduced, resulting in less drag or stiction of the shutter 804 as it moves along the axis of the direction of motion.

By including bumper element 814, the travel of the shutter 804 toward the anchor 826 is predetermined or set deterministically such that the travel of the shutter is stopped when the bumper element 814 contacts the compliant support beam 802. By including bumper elements 810 and 812, the distance of travel of the shutter toward the anchor 822 or 826 can be set in a deterministic manner such that the travel of the shutter is stopped when the bumper element 812 contacts the bumper element 810. Additionally, differing voltages may be applied to bumper elements 810 and 812 to establish an attractive electrostatic field between the bumper elements 810 and 812 and, thereby, enable more efficient and reliable movement of the shutter 804 to a position in proximity to the anchor 822 or 826.

Compliant support beam 806 operates in a similar manner as the operations described with respect to compliant support beam 802 above. Also, bumper elements 816, 818, and 820 operate in a similar manner as the operations described with respect to bumper elements 810, 812, and 814 respectively. In certain implementations, the actuation functions for compliant support beams 802 and 806, and the bumper elements 810, 812, 814, 816, 818, and 820, operate in a complementary manner to move the shutter 804 between positions along the axis of direction of motion 808. The positions may include an open position for allowing light to pass through an adjacent aperture, such as, for example, aperture 508, or a closed position for blocking the passage of light through an adjacent aperture.

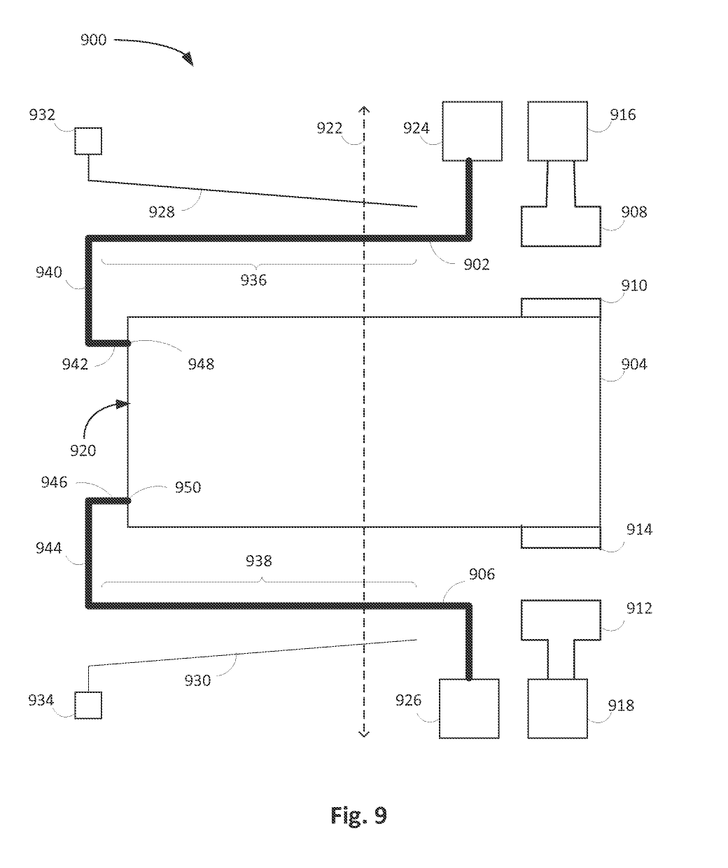

FIG. 9 is another diagram of a shutter assembly 900 including compliant support beams 902 and 906 and bumper elements 908, 910, 912, and 914. In certain implementations, one or more of the bumper elements 910 and 914 are integrally formed with the shutter 904. In some implementations, one or more of the bumper elements 910 and 914 are added to, formed on, or coupled to the shutter 904. One or more of the bumper elements 908 and 912 may be integrally formed with anchors 916 and 918 respectively. One or more of the bumper elements 908 and 912 may be added to, formed on, or coupled to the anchors 916 and 918 respectively. One or more of the bumper elements 908, 910, 912, and 914 may include an electrode.

In certain implementations, the compliant support beams 902 and 906 are connected to a side 920 of a movable shutter 904 facing away from an axis of the direction of motion 922 of the shutter 904. The shutter assembly 900 is a type of electromechanical device used to modulate light for a display as described in further detail with respect to FIGS. 1A-8 herein. The compliant support beam 902 is coupled to an anchor 924 at a first end and coupled to the shutter 904 at a second end. The compliant support beam 906 is coupled to an anchor 926 at a first end and coupled to the shutter 904 at a second end. The shutter assembly 900 also includes drives beam 928 and 930 that are coupled to anchors 932 and 934 respectively. The anchors 916, 918, 924, 926, 932, and 934 may be mounted on a substrate such as substrate 504 or 522 of FIG. 5. In some configurations, the anchors 916, 918, 924, 926, 932, and 934 may be coupled to a layer of material adjacent to substrate 504 or 522 such as, for example, layer 506 or 524 respectively. One function of the anchors 924, 926, 932, and 934 is to suspend the beams 902, 906, 928, and 930, and the shutter 904, a distance away from the substrate. By spacing the shutter 904 a distance away from a substrate, the shutter 904 is allowed to move along an axis of the direction of motion 922. One function of the anchors 916 and 918 is to suspend the bumper elements 908 and 912 such that the bumper elements 908 and 912 oppose bumper elements 910 and 914 respectively.

The various elements of the shutter assembly 900 such as the beams, anchors, shutter may include the materials, properties, dimensions, and arrangements of like elements described with respect to FIGS. 1A-8. In certain configurations, the compliant support beam 902 includes an electrode or actuating portion 936 that opposes the drive beam 928. The drive beam 928 also includes an electrode or actuating portion. As discussed in more detail with respect to FIGS. 2, 3A, 4A, and 4B, the drive beam 928 and compliant support beam 902 coordinate to function as an actuator to move the shutter 904 along the axis of the direction of motion 922. The compliant support beam 906 includes an electrode or actuating portion 938 that opposes the drive beam 930. The drive beam 930 also includes an electrode or actuating portion. Again, as discussed in more detail with respect to FIGS. 2, 3A, 4A, and 4B, the drive beam 930 and compliant support beam 906 coordinate to function as an actuator to move the shutter 904 along the axis of the direction of motion 922.

A voltage differential may be applied between the bumper elements 908 and 910 to generate an electrostatic attractive field to attract the shutter 904 toward the anchor 916. The electrostatic field may be employed in addition to the actuation process between the compliant support beam 902 and the drive beam 928. Also, the arrangement and size of the bumper elements 908 and 910 may be configured to limit or establish a deterministic amount of travel of the shutter 904 along the axis of the direction of motion 922 in the direction of the anchor 916. The bumper elements 912 and 914 may include electrodes and function is a similar manner as described with respect to bumper elements 908 and 910, except that the bumper elements may be configured to limit or establish a deterministic amount of travel of the shutter 904 along the axis of the direction of motion 922 in the direction of the anchor 918. The arrangement of one or more of the bumper elements 908, 910, 912, and 914 within the shutter assembly 900 provides 1) a deterministic travel for the shutter 904 or 2) an extra hard stop voltage to ensure that the shutter 904 efficiently and properly reaches a desired position. Variations of the shutter assembly 900 may be implemented that include one or more of the bumper elements 908, 910, 912, and 914.

The compliant support beam 902 includes a loop back segment 940 that enables the compliant support beam 902 to extend across or traverse to the axis of the direction of motion 922 from the anchor 924 and then extend back toward the axis of the direction of motion 922. The compliant support beam 902 also includes a connector portion 942 that couples the compliant support beam 902 to the shutter 904. The compliant support beam 906 includes a loop back segment 944 that enables the compliant support beam 906 to extend across or traverse to the axis of the direction of motion 922 from the anchor 926 and then extend back toward the axis of the direction of motion 922. The compliant support beam 906 also includes a connector portion 946 that couples the compliant support beam 906 to the shutter 904. The shutter 904 is an example of one type of movable element, body, or component within an electromechanical device.

In certain implementations, the compliant support beam 902 connects to the shutter 904 via connector portion 942 at a connection position 948 along the side 920 of the shutter 904 facing away from, or extending parallel to, the axis of the direction of motion 922. The connection position 948 may be located at any location along the side 920 of the shutter 904. As previous discussed with respect to FIG. 6, one advantage of the loop back segment 940 is that it enables the length of the compliant support beam 902 to be adjusted or configured such that the connector portion 942 can be coupled to the shutter 904 at connection position 948 at any location along the side 920 of the shutter 904. Likewise, the compliant support beam 906 may connect to the shutter 904 via connector portion 946 at a connection position 950 along the side 920 of the shutter 904 facing away from, or extending parallel to, the axis of the direction of motion 922. The connection position 950 may be located at any location along the side 920 of the shutter 904.

By connecting the compliant support beam 902 or 906 to the side 920, the overall length of the compliant support beam 902 or 906 can be reduced because the compliant support beam 902 or 906 can extend a shorter distance back toward the axis of the direction of motion 922, i.e., the compliant support beam 902 or 906 extends back to the side 920 of the shutter 904. With a shorter length, the spring constant of the compliant support beam 902 or 906 is increased, resulting in faster movement of the shutter 904. By coupling the compliant support beam 902 or 906 to the side 920, the amount of stress on the compliant support beam 902 or 906 may be reduced. While FIG. 9 shows an implementation having two compliant support beams 902 and 906, in other implementations, a shutter assembly 900 may use one compliant support beam 902 and drive beam 928, or more than two compliant support beams.

In operation with respect to the implementation shown in FIG. 9, movement of the shutter 902 is effected by applying a voltage to the compliant support beam 902 and a voltage to a corresponding actuator or drive beam 928 spaced away from the compliant support beam 902. An electrostatic field between the actuating portion 936 of the compliant support beam 902 and the drive beam 928 generates an attractive force between the actuating portion 936 of the compliant support beam 902 and the drive beam 928, thereby effecting movement of the shutter 904 along the axis of the direction of motion 922 toward the anchor 924. The greater the length of the actuating portion 936 opposing or adjacently spaced apart from the drive beam 928, the greater the attractive force between the actuating portion 936 and the drive beam 928, resulting in lower pull-in voltage. The length of the compliant support beam 902 may be limited by the beam's other function, which is to support the shutter 904 relative to an anchor 924. If the shutter 904 only requires a short mechanical support, the length of its actuating portion 936 may be reduced, resulting in reduced attractive force.

Additionally, by including a loop back segment 940 in the compliant support beam 902, the compliant support beam 902 can be advantageously connected to the shutter 904 at any position 948 along the side 920 of the shutter 904 without affecting a desired length of the actuating portion 936 of compliant support beam 902. Thus, the compliant support beam 902 can have an actuating portion 936 that extends adjacent the full length of the drive beam 928 to achieve the desired interaction between the compliant support beam 902 and the actuator or drive beam 928. The depicted compliant support beam 902 can then curve back around at the loop back segment 940 to connect the compliant support beam 902 to the shutter 904 via the connector portion 942. Thus, both the desired amount of actuator-support beam interaction and the desired connection location on the shutter are achieved.

By including bumper elements 908 and 910, the distance of travel of the shutter 904 toward the anchor 916 can be set in a deterministic manner such that the travel of the shutter 904 is stopped when the bumper element 908 contacts the bumper element 910. Additionally, differing voltages may be applied to bumper elements 908 and 910 to establish an attractive electrostatic field between the bumper elements 908 and 910 and, thereby, enable more efficient and reliable movement of the shutter 904 to a position in proximity to the anchor 916.

Compliant support beam 906 operates in a similar manner as the operations described with respect to compliant support beam 902 above. Also, bumper elements 912 and 914 operate in a similar manner as the operations described with respect to bumper elements 908 and 910. In certain implementations, the actuation functions for compliant support beams 902 and 906, and bumper elements 908, 910, 912, and 914, operate in a complementary manner to move the shutter 904 between positions along the axis of the direction of motion 922. The positions may include an open position for allowing light to pass through an adjacent aperture, such as, for example, aperture 508, or a closed position for blocking the passage of light through an adjacent aperture.

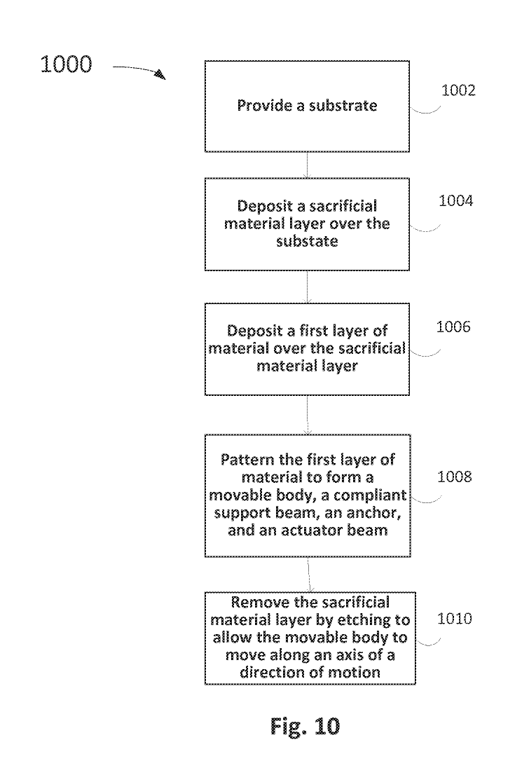

FIG. 10 is a flow diagram of a process 1000 for manufacturing an electromechanical device including a compliant support beam. The process 1000 includes providing a substrate (Block 1002). Then depositing a sacrificial material layer over the substrate. (Block 1004). Then, depositing a first layer of material over the sacrificial material layer (Block 1006) and patterning the first layer of material to form a movable body, a compliant support beam coupled to the movable body, an anchor, and an actuator beam spaced apart from the compliant support beam (Block 1008). The movable body is allowed to be movable along an axis of a direction of motion after the sacrificial material layer is removed by an etching process (Block 1010). The compliant support beam may be coupled to the anchor via a first end and coupled to the movable body via a connector portion. In one configuration, the compliant support beam includes an actuating portion extending from the anchor and in a direction that is transverse to the axis of the direction of motion and away from the anchor. The actuating portion may also be arranged adjacently and spaced apart from the actuator beam. The connector portion may be contiguous with the actuating portion and coupled to the movable body while also extending at least partially back towards the anchor, and being arranged adjacently and spaced apart from the actuating portion.

In a further implementation, a method of manufacturing an electromechanical device includes providing a substrate. Then, forming a MEMS based device over the substrate where the MEMS based device includes a layer of amorphous silicon. Etching the amorphous silicon to form an actuator beam. Etching the amorphous silicon to form a movable body being movable along a direction of motion. Etching the amorphous silicon to form an anchor. Etching the amorphous silicon to form a compliant support beam coupled to the anchor via a first end and coupled to the movable body via a connector portion. The compliant support beam includes an actuating portion extending from the anchor and in a direction that is transverse to the direction of motion and away from the anchor. The actuating portion is also arranged adjacently and spaced away from the actuator beam. The connector portion is contiguous with the actuating portion and coupled to the movable body. The connector portion also extends back towards the anchor and is also arranged adjacently and spaced away from the actuating portion.

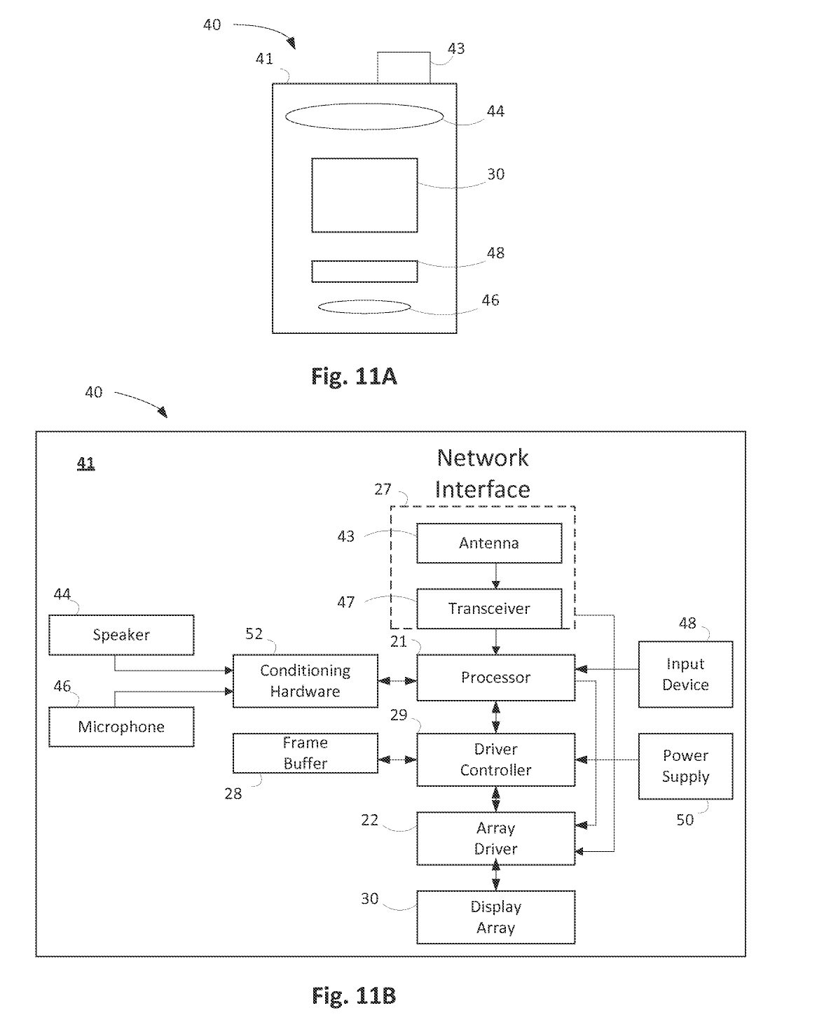

FIGS. 11A and 11B are system block diagrams illustrating a display device 40 that includes a plurality of light modulator display elements. The light modulator display elements may include one or more electromechanical devices such as described with respect to FIGS. 6-10 herein. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an light modulator-based display, as described herein.

The components of the display device 40 are schematically illustrated in FIG. 11A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 11A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to information that identifies the image characteristics at each location within an image. For example, such image characteristics can include color, saturation and grayscale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as a light modulator display element controller). Additionally, the array driver 22 can be a conventional driver or a bi-stable display driver (such as a light modulator display element driver). Moreover, the display array 30 can be a conventional display array or a bi-stable display array (such as a display including an array of light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware components, software components, or combination thereof, and in various configurations.

Variations and modifications can be made to the implementations described above without substantially departing from the principles of the present application. Such variations and modifications are also intended to be included within the scope of the appended claims. Therefore, the forgoing implementations are to be considered in all respects illustrative, rather than limiting of the application.

What is claimed is:

1. An electromechanical device comprising:
a movable body being movable along an axis of a direction of motion;
a first actuator beam; and
a first compliant support beam arranged to support the movable body, having:
a first end connected to an anchor,
an actuating portion connected to and extending away from the anchor and such that the actuating portion crosses an axis of the direction of motion, the actuating portion being arranged adjacently and spaced apart from the first actuator beam, and
a connector portion contiguous with the actuating portion and coupled to the movable body, the connector portion extending at least partially back towards the anchor while being arranged adjacently and spaced apart from the actuating portion.

2. The electromechanical device of claim 1, wherein the connector portion connects to the movable body along a side facing the actuating portion of the complaint support beam.

3. The electromechanical device of claim 2, wherein the connector portion connects on or about a center location of the side.

4. The electromechanical device of claim 1, wherein the connector portion connects to the movable body along a side substantially parallel to the axis of the direction of motion.

5. The electromechanical device of claim 1, wherein the connector portion includes a loop back segment arranged to enable the connector portion to extend back towards the anchor.

6. The electromechanical device of claim 5, wherein the connector portion traverses the axis of the direction of motion.

7. The electromechanical device of claim 1, wherein the movable body includes a shutter.

8. The electromechanical device of claim 1, wherein the shutter includes a bumper.

9. The electromechanical device of claim 8, wherein the bumper is arranged to determine a distance of travel of the shutter in a direction along the axis of the direction of motion.

10. The electromechanical device of claim 9, wherein the bumper includes an electrode.

11. The electromechanical device of claim 8, wherein the bumper is integrally formed on the shutter.

12. The electromechanical device of claim 1, comprising a second actuator beam and a second compliant support beam.

13. The electromechanical device of claim 1, wherein the electromechanical device is arranged as part of a display apparatus.

14. The electromechanical device of claim 13, wherein the display apparatus is arranged to communicate with a processor, the processor being configured to process image data and communicate with a memory device.

15. The electromechanical device of claim 14, wherein the display apparatus receives at least one signal from a driver circuit configured to receive at least a portion of the image data from a controller.

16. The electromechanical device of claim 15, wherein the processor is configured to receive the image data from an image source module, the image source module including at least one of a receiver, transceiver, and transmitter.

17. The electromechanical device of claim 16, wherein the processor is configured to receive input data from an input device.

18. A method for manufacturing an electromechanical device comprising:
providing a substrate;
depositing a first layer of material over the substrate;
patterning the first layer of material to form a movable body, a compliant support beam coupled to the movable body, an anchor, and an actuator beam spaced apart from the compliant support beam, the movable body being movable along an axis of a direction of motion, the compliant support beam being coupled to the anchor via a first end and coupled to the movable body via a connector portion, the compliant support beam including an actuating portion extending from the anchor and in a direction that is transverse to the axis of the direction of motion and away from the anchor, the actuating portion being arranged adjacently and spaced apart from the actuator beam, the connector portion being contiguous with the actuating portion and coupled to the movable body, the connector portion extending at least partially back towards the anchor while being arranged adjacently and spaced apart from the actuating portion.

19. The method of claim 18, comprising coupling the connector portion to the movable body along a side facing the actuating portion of the complaint support beam.

20. The method of claim 19, comprising coupling the connector portion on or about a center location of the side.

21. The method of claim 18, comprising coupling the connector portion to the movable body along an end wall substantially parallel to the axis of the direction of motion.

22. The method of claim 18, comprising forming a loop back segment arranged to enable the connector portion to extend back towards the anchor.
